(19) United States
(12) Patent Application Publication
(10) Pub. No.: US 2008/0071661 A1
(43) Pub. Date: Mar. 20, 2008

(54) Investment product, methods and system for administration thereof

(75) Inventors: Fabien Jeudy, Mumbai (IN); Joel Prough, Lexington, MA (US); Karen Rodeo, Billerica, MA (US); Alexander D. Borskiy, Needham, MA (US); Adele Walsh, Co. Kilkenny (IE)

Correspondence Address: WOLF GREENFIELD & SACKS, P.C., 600 ATLANTIC AVENUE, BOSTON, MA, 02210-2206, US

(73) Assignee: Sun Life Assurance Company of Canada, Toronto (CA)

(21) Appl. No.: 11/796,626

(22) Filed: Apr. 27, 2007

Related U.S. Application Data
(60) Provisional application No. 60/795,887, filed on Apr. 27, 2006.

(51) Int. Cl. G06Q 40/00; G06F 17/30; G06F 17/40

(52) U.S. Cl. 705/36 R; 705/37; 705/39

(57) ABSTRACT

A method of providing an investment product, and supporting administration system and annuity product. The product is an investment contract or agreement preferably of an annuity type, providing investment returns substantially mirroring the performance of an index and allowing an investor to begin receiving or deferring periodic payments on or after a predetermined date, at the election of the investor; if the investor elects to defer one or more payments, the investor may later elect to receive said one or more deferred payments, at a date of that entity's choosing, which will also start the delivery of periodic payments. During the deferral, the deferred payments earn a return tax-deferred (subject to currently enforceable tax laws). The investment return is preferably a function of an index but not less than zero, periodically (e.g., annually) locking in past gains and assuring against losses that can eliminate past periods' gains.

### CROSS-REFERENCE TO RELATED APPLICATIONS

This application claims the benefit, under 35 U.S.C. § 119(e) of provisional application serial no. 60/795,887, filed Apr. 27, 2006, titled “EQUITY INDEXED ANNUITY INVESTMENT PLATFORM.”

### BACKGROUND OF INVENTION

1. Field of Invention

This invention relates to the fields of investment products and data processing. More particularly, it relates to a method of providing an annuity type investment product, to corresponding annuity products or certificates having specified terms and conditions, and to a system for the administration of such products. Still more specifically, the invention relates to an investment method, annuity product, and system for administering same wherein the product provides to the purchaser one or more of: a benefit which allows the purchaser both to set a date when payments potentially may start to be made to the purchaser, and to defer receipt of those payments while allowing them to accumulate value until a payout is desired; such a benefit allowing the purchaser to elect to set said date within some time period following purchase; and the deferral of charging the purchaser for the benefit until the election is made. A system is disclosed for efficiently administering such a method and product for large numbers of purchasers.

2. Background

Those who make money providing investment and investment risk management (mitigation) services to others include insurance companies. Some insurance companies provide a type of investment product called an annuity contract or, for short, simply an annuity. Annuity products are investment contracts, typically sold by an issuer or similar issuer, to an investor. The issuer agrees, in return for one or more payments by the purchaser (i.e., investor), to make payments (distributions) to the purchaser starting some time in the future, usually periodically, either for a fixed term or until the death of the purchaser or another individual. The issuer invests the purchaser's payments to generate earnings to cover purchaser benefits and guarantees, the issuer's expenses and the issuer's profit margins.

In some cases, although the purchaser may still be an individual, the individual is a member of a group that has negotiated with the issuer on behalf of a collection of its members. In such an arrangement, there is actually a master contract between the issuer and the group sponsor. Individual members of the group form contracts with the issuer in accordance with the terms set out in the master contract. The individual receives a document, usually called a “certificate,” evidencing an instance of a contract under the group contract, the term “certificate” making it clear there is a master contract supplying various terms. Without limitation as to a group arrangement or individual contract (non-group) arrangement, the individual party making the investment will herein be referred to as the “Certificate Owner.” The term “certificate” will refer to an annuity contract made directly between an individual and an issuer without an intervening master contract, or indirectly with the aid of a master contract. The party with whom the issuer has the direct relationship will be referred to simply as an “entity,” which term shall encompass an individual Certificate Owner as a natural person, as well as an employer or other organization holding a master contract, unless context requires otherwise.

Typically, the Certificate Owner either pays a one-time, lump sum premium to the issuer or the Certificate Owner agrees to make periodic (e.g., annual) payments for a period of years. The issuer invests the premiums and, by contract, guarantees a stream of payments starting at some certain date in the future (e.g., a birthday of the Certificate Owner or contract anniversary) for the life of the Certificate Owner (or some other individual) or some fixed period of time (such as five, ten or twenty years). In many jurisdictions, investment returns accumulate tax-deferred under an annuity contract, provided the contract complies with applicable legal requirements.

In terms of investment return to the Certificate Owner, there are mainly two types of annuity contracts, fixed and variable. With a fixed annuity contract, the issuer guarantees a fixed rate of return no matter how well it does or does not fare investing the participant's funds. At some date certain or upon the occurrence of some event, the issuer then is required to begin periodic or lump-sum payments to the Certificate Owner or his/her heirs, using a pre-agreed interest rate to compute the account value and the payments. Thus, there is an accumulation phase in which the intention is for the account value to build and then there is a payment phase in which payments are made and the purchaser may or may not have access to cash surrender value.

Fixed annuities that meet minimum non-forfeiture requirements are not securities. The minimum non-forfeiture values vary by jurisdiction. Upon surrender of the annuity contract, the issuer then has to pay the greater of the actual cash surrender value of the annuity or this non-forfeiture minimum value.

Variable annuities are similar to fixed annuities, to a degree, but the issuer invests the Certificate Owner's premiums (less some administrative charges) according to the Certificate Owner's directions and thus does not guarantee investment performance of the contract. A variable annuity therefore is treated as a securities investment and is regulated as such. Typically, the Certificate Owner is offered a range of investment options (i.e. funds) to which he or she may direct his or her account for investment. Such offerings may, for example, be risky or conservative—such as stock finds, balanced finds, bonds and money market instruments. The investor (i.e., Certificate Owner or participant) makes his/her own selection and also takes all the risk. Like fixed annuities, none of the earnings are currently taxable and the account value can grow tax-deferred over the years, to a significant portfolio value. The variable annuity purchaser is hoping, in choosing a variable rather than a fixed contract, that he/she can pick investments that will, over the term of the contract, outperform the interest rate of a fixed contract.

Various companies have created and offered riders to variable annuities contracts to try to ameliorate the risks and make them more suitable to investors. An example is a rider that guarantees that the accumulated funds will be no less in amount than the starting value (i.e., initial premium). In other words, if the purchaser pays a one-time premium of $100,000, the insurance company guarantees that the accumulated value in (e.g.,) 10 years will be no less than $100,000 invested, irrespective of the performance of the investment options selected. (The issuer may put some restrictions on the available investment options, to manage its risk.) Often, the Certificate Owner can, at any time, reset the guarantee for another period—e.g., 10-years. Thus, if the $100,000 became $120,000 after one year due to favorable investment performance, the annuitant (e.g., Certificate Owner) could continue his/her $100,000 guarantee in year 10 or opt to reset the guarantee at $120,000 in year 11.

A third case, which is often a special type of a fixed annuity, is an equity-indexed annuity. It is a special case of the fixed annuity because, in contrast to a variable annuity, the issuer directs how the funds are invested, not the Certificate Owner, and contract guarantees typically meet minimum non-forfeiture requirements. Rather than declaring a fixed interest rate that will be credited to the customer, the issuer declares interest credits based on participation in the performance of an index, with the interest credit never to be less than zero. As an example, the Certificate Owner may receive 75% (or some other portion) of the increase in the S&P 500 Index if positive, and zero if not positive. Except as otherwise stated, an equity-indexed annuity (EIA) may be considered to be in the fixed income category for purposes of this document; the nature of the non-forfeiture minimum amount is not relevant to further discussion.

Typically, for both types of fixed contracts, the issuer is an insurance company that guarantees values at least equal to minimum non-forfeiture requirements will be paid to the Certificate Owner. On variable annuities, however, there is no protection against the holder choosing investments that lose both principal and investment returns. Even if the issuer is willing to guarantee payback of the principal payments (at a cost), it cannot reasonably do the same with respect to investment returns—there are too many variables and too much potential exposure. That could leave a Certificate Owner in the position of receiving payments for a much shorter time or in a much smaller amount than he/she had planned.

Moreover, if a Certificate Owner were to defer receiving payments (e.g., electing to have payments start in fifteen years from purchase, instead of ten years), not only the principal but also the earnings that would have been paid out and that are instead left in the account to grow will, in fact, be at risk. They (the deferred payments) might grow to a large amount following which the value of the investment might plummet before payments become due, or that might happen during the payment phase, wiping out some or all of the gains and jeopardizing future payments.

All of the foregoing types of annuities allow Certificate Owners to withdraw their funds at any time or at predetermined times. A Certificate Owner can therefore create a stream of income by simply withdrawing an amount (let's say, for example, $5000) every year. However, this stream of income is not guaranteed for life. On variable annuities, the investment funds can decline in value significantly. On fixed annuities, the Certificate Owner can outlive the accumulated funds. On indexed annuities, the funds are typically guaranteed but usually at a lower rate than fixed annuities so the Certificate Owner can outlive the funds sooner than he or she would on a traditional fixed annuity.

To secure a lifetime income stream, the Certificate Owner can ‘annuitize’ and start the income/payment phase. All three types of annuities offer this. To annuitize means to hand over the accumulated value in the account to the issuer in exchange for an agreement committing the issuer to make a guaranteed stream of payments payable for so long as the Certificate Owner lives. The Certificate Owner must forfeit all of the accumulated value in order to secure the right to the guaranteed income stream. In committing to the guaranteed payment stream, the issuer assumes risk on the Certificate Owner's life expectancy. Let's say the accumulated value is $500,000. A male 65 will (at the time this is submitted) get about $38,000 a year for the rest of his life if he annuitizes, using currently accepted life expectancy data and a typical rate of investment return offered in the marketplace. It takes many years before the Certificate Owner gets his $500,000 back but eventually the return will be attractive, especially if the Certificate Owner lives a very long time.

To address the loss of liquidity upon annuitization, some issuers have come out with riders (e.g., a guaranteed minimum withdrawal for life benefit) that allows the Certificate Owner to make periodic withdrawals from an amount representing his/her “own” accumulated funds; if the accumulated funds run out due to poor investment performance or because the Certificate Owner outlives the funds, then the issuer will cover the shortfall by continuing to pay the periodic amount for so long as the Certificate Owner lives. For the aforesaid male at age 65, the periodic withdrawal typically would be about $25,000 per year (instead of the $38,000 a pure annuity would yield) but he has access to all of the remaining accumulated funds at any time. The Certificate Owner therefore gets a lower lifetime income but retains access to his/her funds. Thus, the Certificate Owner can secure a lifetime stream of $38,000 per year by annuitizing and lose access to all of the $500,000, or the Certificate Owner can secure a lower lifetime stream of $25,000 per year and retain all access to the remaining value of the $500,000. $13,000 per year is sacrificed for liquidity.

Another rider that alternatively may be issued is a guaranteed minimum withdrawal benefit, which follows a return of premium design. The return of premium design guarantees periodic withdrawals at least equal to premium invested, irrespective of investment performance, but does not guarantee periodic withdrawals for life.

Investment risks can be alleviated with fixed and indexed annuities by providing a minimum positive investment earning at all times. Some variable annuities offer riders to cover investment risks by guaranteeing minimums on account values, but these guarantees are at specific points in time (e.g., after 10 years) and not at all times. Longevity risks can be reduced or eliminated with all three types of annuities by annuitizing. Lifestyle risks can be mitigated during the accumulation phase only; upon annuitization, the Certificate Owner forfeits all of his/her accumulated funds to the issuer, so none of those funds are available to maintain his/her lifestyle in case of accident or health problems or other needs. For example, the aforesaid 65-year old male can decide not to annuitize (risking that he will outlive payments) and thus make sure he has sufficient funds available in case of a critical illness. If he annuitizes, by contrast, he is covered against the longevity risk but now doesn't have access to the funds to maintain his lifestyle or to meet emergency needs.

Many individuals shy away from the risks inherent in variable annuities; and with respect to fixed annuities, despite the protections afforded, many individuals choose not to purchase such annuity products. Chief among their reasons are that the guaranteed rate of return is perceived as low and that they do not want to tie up their assets for a substantial number of years before withdrawals begin (because they may experience “lifestyle” needs for their funds). For example, parents of a young child may recognize that they will have to tap into their savings when their child goes to college. If those savings are locked up in an annuity contract, and are not accessible, then an annuity contract may be seen as a disfavored form of investment for them. It lacks the flexibility and the withdrawal provisions that such parents may require. Or a young couple or single person may foresee the desire to possibly use some assets for the down payment on a home some years hence, if other resources are inadequate. Others may, for a variety of reasons, believe that their personal finances cannot be predicted over a substantial period of time and also, therefore, may not feel comfortable tying up their funds. Others may simply view the rate of return of a conservative annuity investment, especially a fixed rate contract, to be lower than they can obtain from alternative investments. Some properties of annuities contracts thus make them less attractive than other types of investments (e.g., tax-free bond funds) and limit the ability of insurance companies to attract certain individuals as annuities buyers, particularly younger potential buyers.

A need thus exists to provide a broader range of potential investors with the security of an annuity contract but enhanced withdrawal flexibility and (in some cases) improved rates of return over fixed annuities. A need also exists for an annuity contract that allows a Certificate Owner to be covered against longevity risks and lifestyle (need) risks at the same time. Though these needs have long existed, they have not been effectively addressed in annuity products.

In general, while it is at least possible to have a single annuity contract between one annuitant (e.g., Certificate Owner) and one issuer, an issuer is typically an insurance company or the like desirous of making a substantial business out of selling and administering annuity contracts. Creating a viable business of this type typically requires an issuer to sell a given type of annuity product to thousands or tens of thousands of participants. To be competitive in the marketplace, an issuer has to, among other things, operate efficiently and spread its administrative cost structure and risk profile over a large number of annuity contracts. In turn, such a volume of contracts typically is administered with the aid of complex data processing systems and methods, to assure that the issuer and participants are living up to their contractual obligations. An annuity product that meets the objectives set forth herein requires a good deal of data processing and when that processing is aggregated to administer a large number of contracts, it is important that the processing be efficient. If the issuer has previously been in the annuities business, it may also be important that the necessary data structures and algorithms add the smallest reasonable processing burden and memory demands on the necessary data processing systems or additions to pre-existing data processing systems.

### SUMMARY OF INVENTION

A first aspect of the invention is a method of providing to an entity an investment product of an annuity type. This method comprises arranging with the entity to provide, for at least a specified term, investment returns as a function of the performance of a predetermined index; arranging to begin periodic payments on or after a predetermined date, at the election of the entity; and in response to the entity deferring to receive one or more of said payments or portions thereof, allowing the entity to receive all or some portions of the deferred amounts at a later date of the entity's choosing. Such method may further include, in response to the entity electing to receive said deferred payments, making said one or more deferred payments or portions thereof to the entity and (optionally) commencing periodic payments to the entity. There may be no payment by, or diminution of investment return to, the entity by virtue of having a right to make said election, until said election is made. The method may include changing said function in response to said election, to change the investment returns as a function of the index.

Further, in this and other aspects and embodiments, there may be protection against investment losses during an interval and/or no charge to the entity for the right to make said election unless investment returns are positive during a predetermined interval.

Yet another aspect is a method of providing by an issuer to an entity an investment product of an annuity type, comprising: arranging with the entity to provide, for at least a specified term, investment returns substantially determined by the performance of one or more investment options such as mutual funds or funds of funds selected in accordance with an acceptable risk profile; arranging to begin periodic payments on or after a predetermined date, at the election of the entity; and in response to the entity deferring to receive one or more of said payments or portions thereof, allowing the entity to receive all or some portions of the deferred amounts at a later date of the entity's choosing. Such method may further include, in response to the entity electing to receive said deferred payments, making said one or more deferred payments or portions thereof to the entity and (optionally) commencing periodic payments to the entity.

Still another aspect is a method of providing to an entity an investment product of an annuity type, comprising: arranging with the entity to provide, for at least a specified term, minimum fixed investment returns; arranging to begin periodic payments on or after a predetermined date, at the election of the entity; and in response to the entity deferring to receive one or more of said payments or portions thereof, allowing the entity to receive all or some portions of the deferred amounts at a later date of the entity's choosing. Such method may further include, in response to the entity electing to receive said deferred payments, making said one or more deferred payments or portions thereof to the entity and (optionally) commencing periodic payments to the entity.

Another aspect is an investment (e.g., annuity) product comprising an agreement, between an issuer and an entity, embodied in a tangible medium, and providing therein a right exercisable by the entity to begin receiving periodic payments on or after a predetermined date following payment of a premium, at the election of the entity; and further providing that if the entity elects not to receive one or more payments, the entity may elect to receive said one or more payments or portions thereof at a later date of the entity's choosing without interfering with receipt of subsequent payments or payment amounts. Such annuity product of claim may further provide that the entity's premium is to be invested in fixed income instruments and possibly options. It also may further provide that the entity's premium is to be invested in one or more investment options selectable by the entity and acceptable to the issuer.

Still one more aspect is a computer-implemented system for administering investment (e.g., annuity) contracts with guaranteed (e.g., for lifetime) withdrawal benefits allowing each of a plurality of Certificate Owners to elect a date to begin receiving annual payments, defer payments when said date arrives, and obtain later payment of the deferred payments amounts or any part thereof, without impairing the right to future payments. Such system may comprise: a data store; a data structure in the data store, wherein there are maintained for each Certificate Owner at least one investment account and at least one interest account; and one or more processing modules which operate to implement any of the above methods. The system may further include a participation rate table constructed and arranged to receive and store a participation rate to be used if a certificate's lifetime withdrawal benefit is inactive and a participation rate to be used if a certificate's lifetime withdrawal benefit is active; and a processing module to adjust a certificate owner's investment account value using an applicable one of said participation rates and an index value. The processing module may make no adjustment to said investment account if the index value is not positive.

Yet another aspect is a computer-implemented method of administering a plurality of annuity accounts, comprising: establishing in a data store a record of an index value for each of said annuity accounts; establishing in a data store a record of at least one participation rate for each of said annuity accounts; maintaining in a data structure for each of said annuity accounts a record of whether a guaranteed (e.g., lifetime) withdrawal benefit feature of the account has been activated; maintaining in a data store an interest sub-account and an index sub-account for each of said accounts; and computing for each said index sub-account an investment value change in response to a predetermined function using the record of whether a lifetime withdrawal benefit feature has been activated for said account, a corresponding participation rate for the account and an index value for said account.

According to one more aspect of the invention, an issuer may sell, contract, or otherwise grant to, or arrange for an entity called a Certificate Owner (e.g., a customer, but generally, an individual or a business or other entity—also referred to as a “purchaser” even if not the entity that bought or arranged for a master annuity agreement) to receive an annuity product which is neither a fixed annuity nor a variable annuity product, but an equity-indexed annuity product with unique characteristics. The issuer, irrespective of the investment(s) in which the account is invested, declares and pays to the Certificate Owner's account, from time to time, interest credits based on the performance of an index. That is, the entity receives in his or her account, from time to time, a change (hopefully an increase but, as explained elsewhere, it could be a zero change and the possibility of a decrease is not outside the scope of some embodiments) in value which is a function of the change in the value of the index. Of course, an index value may also decline over an interval and the annuity account may be allowed (as a consequence of said function) to decline in value in like fashion. However, in some embodiments, the issuer also may guarantee the account against any loss in value (or, more generally, guarantee against more than a specified loss) over a specified interval. For example, the issuer may guarantee that on December 31 of each year, the account value (in the absence of withdrawals) will be no less than it was on January 1 of the same year. As a more particular example, the Certificate Owner may receive, yearly (perhaps on the anniversary of the contract or on the Certificate Owner's birthday), 75% (or some other function) of the change in the S&P 500 Index (i.e., if the S&P 500 Index is the selected index) if that change is positive and zero if the change is not positive.

The functional relationship between the index and the change in account value may provide that the account value will change more than the index change (percentage-wise) but more typically the change will be equal to or less than the index change, as in the 75% example. Without loss of generality, it will be assumed hereafter that the functional relationship is a simple percentage relationship and the account value change will be the change in the index multiplied by a factor, called a “participation rate” (and is the aforementioned percentage or its decimal equivalent). Of course, any other relationship acceptable to the parties may be used and certainly more complex functions are possible.

Moreover, in some embodiments, the issuer may provide, in the investment product, a so-called guaranteed withdrawal benefit which allows the Certificate Owner to separately notify the issuer of its election of a date when payments potentially may start to be made to the Certificate Owner, while permitting the Certificate Owner to defer receipt of those payments (in part or total, and potentially subject to a maximum deferral limit) and allow them to accumulate value until the Certificate Owner later desires and requests a payout. (When the guaranteed withdrawal benefit provides for payments for the life of the Certificate Owner or another party, it is called a “Lifetime Benefit” or “Lifetime Withdrawal Benefit.” Although the narrower term “Lifetime Withdrawal Benefit” is employed at times herein, unless it is clear that the product expressly has to provide payments for life, such term should be understood to encompass the more generic non-lifetime-defined guaranteed withdrawal benefit.)

Preferably, in some embodiments the Certificate Owner may have the right to withdraw any deferred payment (in part or total, and potentially subject to a maximum deferral limit) at any time after such payment has been deferred. In that type of embodiment, the deferred payment (and possibly any earnings thereon) effectively is treated as an amount in a sub-account requiring its own accounting.

In some embodiments, the product may require an affirmative notification from the Certificate Owner of a decision to set a date for the beginning of the benefit. In other embodiments, the product may contain a default date on which, in the absence of notification by the Certificate Owner, the benefit will begin. So the Certificate Owner may have to do nothing unless it wishes to change the date. In either of these situations, we refer to the Certificate Owner as “electing” to receive the lifetime benefit payments or electing to not receive the lifetime benefit payments, equivalently.

A further aspect of the invention is a system for maintaining accounts for such annuity products. The system preferably includes a computer platform for managing the record-keeping for investment performance, payments to Certificate Owners, funds available for payment to Certificate Owners, and so forth. The operation of an exemplary account management system will be discussed below, but it should be understood that the described arrangement is only an example. Any suitable computer platform may be employed. It may be a stand-alone system, a distributed system, a programmed general purpose computer(s) or a special-purpose computing implementation, among possibilities.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flow chart of a method according to some embodiments of the invention, for managing a Certificate Owner's accounts;

FIG. 2 is a flow chart providing a high level illustration of the implementation of an exemplary process for managing a certificate owner's account in an embodiment in which a lifetime withdrawal benefit is provided, as set forth herein;

FIG. 3 is a diagrammatic representation of tables comprising a data structure usable in implementing various embodiments of the invention;

FIG. 4 is a flow chart providing a high-level illustration of anniversary processing; and

FIG. 5 is a diagrammatic illustration of an inventive system for administering products, and implementing methods, according to aspects of the invention discussed herein.

### DETAILED DESCRIPTION

Examples are now given of a new method for issuers to formulate annuity and annuity-like products, the resulting products, and an example of a system for their administration. The invention, however, is not limited to these examples. It is not limited in its application to the details of construction and the arrangement of components or acts or steps set forth in the following description or illustrated in the drawings. The invention is capable of other embodiments and of being practiced or of being carried out in various ways. For example, aspects of the invention such as the Lifetime Benefit are applicable not only to equity-indexed annuities, but also to variable annuities and fixed annuities and other investment products. Thus, although in the main example these various aspects are integrated into a single product, it should be appreciated that they may be practiced separately or in any combination.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. As used herein, unless explicitly or implicitly from context it is indicated otherwise, the term “issuer” will be used synonymously with “issuer” though an annuity may be issued by an entity that does not satisfy a regulatory definition of an issuer.

According to one aspect, an issuer may create and sell to a Certificate Owner an annuity or annuity-like product having a payment deferral feature as defined herein. According to the payment deferral feature, such a product provides that once a certain date (the “payment entitlement date”) is reached or a certain amount of time has elapsed, the Certificate Owner is entitled to begin receiving periodic payments (e.g., annual payments or withdrawal amounts). The contract may be written such that payments may start automatically unless the Certificate Owner gives notice to the contrary or such that payments may not start until the Certificate Owner gives notice to do so (i.e., a “no action” default or an “action required” default). In a typical embodiment, once payments start, they shall continue until the policy terms state otherwise, but it is not outside the scope of the invention to provide otherwise.

Once the payment entitlement date is reached, the Certificate Owner can decide when to have the issuer commence periodic payments. (The annuity product preferably provides a table, formula or other method for determining the maximum amount of payments so as not to reduce future benefit guarantees, or it allows the Certificate Owner, prior to annuitization, to set an amount.) Typically, the decision is made annually by the Certificate Owner providing (or not providing, as the case may be) to the issuer a notice to commence payments or defer payments. If a payment is deferred (in part or total, and potentially subject to a maximum deferral), the amount of the payment stays in the investment program of the annuity contract, earning tax-deferred interest, dividends and/or gain/loss in value per market activity (subject to currently enforceable tax laws applicable in the jurisdiction where the annuity is sold). However, and in a departure from other known instruments, the Certificate Owner has the right to request payment of all or any part of the deferred payments at any time thereafter. For example, if the annuity contract provides that on February 15 the insured is entitled to start receiving annual payments of $5000 each, and the Certificate Owner defers three such payments, the Certificate Owner may elect on July 22 following the third deferral to have the issuer send a payment of up to $15,000—the sum of the three deferred payments (let's say, for example, for a college tuition payment). Those three deferred payments may have earned or gained in value perhaps another $2500 during the deferral period, so the account balance grew tax-deferred and the Certificate Owner was able to liquefy his assets when they were needed, while capturing that gain tax-deferred (subject to currently enforceable tax laws applicable in the jurisdiction where the annuity is sold). The Certificate Owner also will now start receiving his/her $5000 per year payments. The withdrawal of cumulative deferred funds does not reduce future annual payments.

An example is provided below of a certificate for a group deferred index-linked fixed (i.e., equity-indexed, as opposed to variable) annuity contract in accordance with the teachings herein. That is, there is an underlying master contract between an issuer and a group entity. The master contract may also be referred to as a certificate or master certificate, but the master certificate is not to be confused with the Certificate Owner's certificate which constitutes his or her annuity contract. (Note that an index-linked annuity is only one type of embodiment, and as stated above, the invention also relates to variable annuity, fixed annuity and other investment products.)

The general structure of such certificates tracks industry norms.

In general, the annuity contract provides and is administered to provide for the following operation:

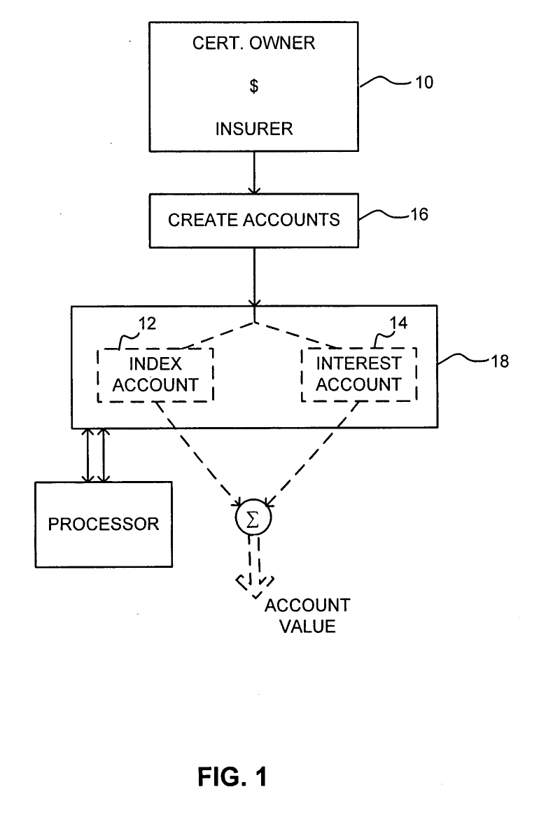

With reference to FIG. 1, the Certificate Owner (participant) pays to an issuer a premium on the date of issue of the certificate. Act 10. In a supporting administrative system (a computer system, typically), two sub-accounts are created for the participant's annuity account, an Index Account 12 and an Interest Account 14. Act 16. (Such sub-accounts may be embodied as or in dedicated portions of a memory or memories 18.) The Index Account is that sub-account upon which index credits are determined and applied. The issue premium—or at least most of it—typically is allocated to the Index Account. However, the participant also may be allowed to pay the issue premium in installments, in which event some number of payments or payments for a certain duration also may be allocated to the Index Account as they are received (possibly less some administrative charge). Thus, in the first year, the Index Account contains the initial premium less any withdrawals. In subsequent years, it is the prior year's ending value less any withdrawals from the Index Account, plus any Index Credits and transfers from the Interest account. Index Credits, discussed below, are the investment gains linked to use of an index.

The Certificate Owner also may be allowed to pay additional premiums at later dates—for example, any time prior to the “annuity date.” For administrative convenience, during any given certificate year, it is preferred that additional premiums received at the beginning of the year (e.g., prior to the end of the first certificate month) be allocated to the Index Account but that any other additional premiums be allocated to the Interest Account. Of course, in a given contract, these terms may be varied.

The account value at any given time is the sum of the Index Account value and the Interest Account value. In turn, the Index Account value typically may be the sum of (a) premiums allocated to the Index Account, (b) Index Credits, (c) transfers from the Interest Account, and (d) a deduction for withdrawals from the Index Account (possibly further reduced by an administrative charge). Periodically, such as at the end of each certificate year, an Index Credit may be added to the Index Account. This may also occur, for example, on the date certain benefits become payable, such as death benefits. At the time an Index Credit is added to the Index Account, a predetermined function is employed to determine the Index Credit. For example, and not to express the only possible function, the Index Credit may equal the balance of the Index Account multiplied by some “Index Return Factor.” While it is possible that one may choose to allow a negative Index Credit value, which will therefore diminish the value of the Index Account, it is preferred that the Index Credit Return Factor (and function) not be allowed to go negative, regardless of the performance of the equity index (or the like) on which it is based. Hence, under one expression shown below, the Index Credit may be the Index Account, on the aforesaid date, multiplied by the greater of 0 and a factor that scales with index growth during the prior year. A good example of an appropriate function is

$$I C = I P R \times \frac{( Avg I V - I V B )}{I V B} ,$$

where IC equals the Index Credit rate;

Avg IV equals the average of the Index Values;

IVB equals the Index Value at the beginning of the certificate year; and

IPR is the Index Participation Rate, which will be discussed below.

The Interest Account value equals the premiums allocated to the Interest Account, less withdrawals and transfers from the Interest Account, both premiums and withdrawals/transfer accumulating at the Interest Account rate. Withdrawals (i.e., payments) during a certificate year may be taken from the Interest Account first until it is fully depleted, with the balance coming from the Index Account. This is not required, however. At the end of each certificate year, any balance in the Interest Account preferably is transferred to the Index Account after Index Credits have been added to the Index Account.

The “index” referred to herein is a financial index. Often it is an index relating to the performance of a group of equity securities sufficiently large and diverse as to allow the issuer to reduce to an acceptable degree the risk that market volatility and payment timing will cause the premiums plus investment returns to be inadequate to fund the contractual payment stream to which the issuer obligates itself. Typically, well-established indices are those such as the Standard and Poor's (S&P) 500, Russell 2000, Dow Jones Industrials Average, various bond indices, etc. An issuer may create its own index or use an index published by another organization. The issuer also may use an index not defined by investment instruments such as stocks and bonds, such as, for example, the consumer price index (CPI). The “interest” performance of the annuity account will reflect the performance of a group of securities (preferably reflecting a broad view of the stock market) but the Certificate Owner will not have an ownership interest in any particular stocks; it will only own a contractual obligation of an issuer. It will be up to the issuer to achieve an adequate return on its investments or to pay interest out of its own funds.

The Certificate Owner is protected against a decline in the index from year to year if the index credit must be greater than or equal to zero. The issuer typically will set the index participation rate (IPR) based on considerations such as the competitive environment, economic environment, expense structure and desired profit margins. Preferably, the IPR is announced prospectively by the issuer and any Certificate Owner who is not satisfied with the announced IPR can surrender his or her certificate and close out his or her account for an appropriate cash surrender value.

Preferably, the Certificate Owner is not charged for the deferral of withdrawals benefit if the investment earnings linked to the external index are not positive. Prior to the benefit being exercised, the investment returns may be, for example, 75% (or some other percentage) of the index growth, subject to a floor of zero. Once the benefit is exercised, the investment returns may be changed (as discussed above) to pay for the benefit—e.g., to 65% of the index growth but still subject to a floor of zero. Thus, the customer does not pay for the benefit unless he/she makes an investment profit. The customer is guaranteed to never loose a penny on the investment before and after the benefit is exercised.

As a second aspect, the unique annuity contract presented herein provides a lifetime benefit (the “Lifetime Benefit” or “Lifetime Withdrawal Benefit”) that may be exercised (i.e., elected) before the “annuity date.” Typically, the annuity date is a date established in the certificate at which mandatory annuity payments must commence. The annuity date often may be changeable by written notice, on agreed terms. For example, in the specimen certificate provided below (Example A), the Certificate Owner may change the annuity date by providing thirty days' written notice prior to the existing annuity date, provided that the new annuity date is (a) after the end of the first certificate year, (b) no later than a mandatory annuity date (e.g., set by law for the commencement of payments), and (c) falls on the first day of a calendar month. The product may further provide a minimum or starting date before which, or other conditions under which, the Lifetime Benefit may not be elected.

Thus, the Lifetime Benefit is exercisable at the option of the Certificate Owner. Once the option is exercised, the issuer determines the “lifetime income” which will be used in determining payments. The lifetime income amount is the “benefit value” multiplied by the “lifetime factor” (also called “lifetime benefit factor”) based on the then-attained age of the person covered under the benefit, typically (but not necessarily) the owner or holder of the certificate.

A “lifetime withdrawal balance” is used to track the maximum amount that can be withdrawn without affecting the lifetime income. It may equal the lifetime income on the date of exercise of the lifetime withdrawal benefit, reduced by any withdrawals, increased by the amount of the lifetime income at the end of each certificate year, and increased by any increase in the lifetime income when a premium is received.

Once the mandatory annuity date is reached, tax laws generally require, and therefore the certificate typically provides for, mandatory withdrawal of an amount no less than the lifetime income amount, by the end of each certificate year.

The lifetime income is increased if a premium is received after the lifetime withdrawal benefit has been exercised. The increase may, for example, equal the premium multiplied by the lifetime factor based on the then-attained age of the person covered under the benefit.

Correspondingly, the lifetime income may be reduced if a withdrawal exceeds the lifetime withdrawal balance or any required minimum distribution, if higher. The resulting new lifetime income may be the lifetime income prior to the withdrawal multiplied by, for example, the ratio of (a) the account value after the withdrawal divided by (b) the account value less the lifetime withdrawal balance, immediately prior to the withdrawal.

When the index used in the contract is published by a third-party, obviously the issuer has no ability to guarantee that the index will remain available and that it will remain substantially unchanged from its original constitution at the time the annuity contract is purchased. Therefore, the issuer preferably will retain the right to substitute a new index for any prior index that has been in use. A substitution may have to be approved by regulatory officials.

The payment terms for such an annuity contract may be substantially the same as many prior art annuity contracts. For example, annuity payments typically are made on a monthly basis unless the payee chooses another frequency of payments, and the issuer may reserve the right to change the frequency of payments in order to avoid making payments of less than some selected minimum amount. Further, as is typical, the issuer may reserve the right to make a lump sum payment if the total to be paid out is less than some predetermined amount. Once payments start, they may be made according to a single predetermined arrangement or there may be optional arrangements electable by the annuitant, a beneficiary or pursuant to some event.

System

In a first example form, a system for managing annuity products as taught herein comprises a suitable information processor including a plurality of information processing modules constructed and arranged to perform the tasks necessary to implement the products and processes defined herein. Such modules may be implemented in various ways such as with suitable software modules executing on suitable processing units. The processing units may include mainframe computers, one or more personal computers, a network of personal computers and/or servers or other computing system, server, etc. having one or more processors or processor cores, and suitable memory and information store(s). One or more modules may include dedicated logic, one or more application-specific integrated circuits (ASICs) or other suitable forms of processing elements. Preferably, the system includes communications capability such as the capability to receive and transmit information over the global Internet. In the information store, the system builds files or records for each annuitant and the accounts maintained for him or her. The store preferably also maintains parametric data defining each customer's annuity contract details—e.g., annuity date, anniversary date, annuitant birthday, index or fund identification, etc. Many system implementations are possible. At a high level, most will effectuate some combination of the elements specified above. Some implementations may be limited in scope, only allowing annuities or other investment products within certain limited parameters. Others may allow a broader range of options. For example, investment options may be fixed in some systems and selectable in others. Some systems may employ only well-known market indices and others may employ proprietary indices. Some embodiments may acquire index information through electronic communications feeds and other systems may require manual input of index values. However, when implementing such a system as a data processing platform, irrespective of how processing is achieved, care should be taken to attend to the need for efficiency in data structure and algorithm design. To administer thousands or tens of thousands of annuity certificates, or more, especially in embodiments providing a range of flexibility, involves a considerable amount of data processing.

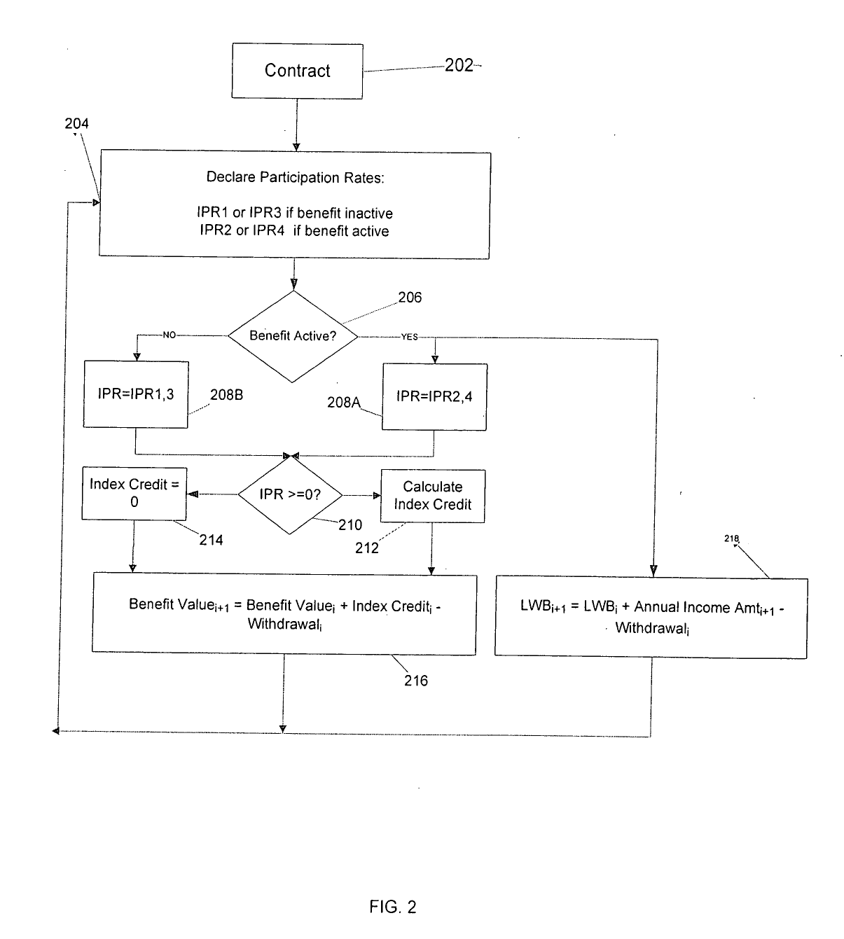

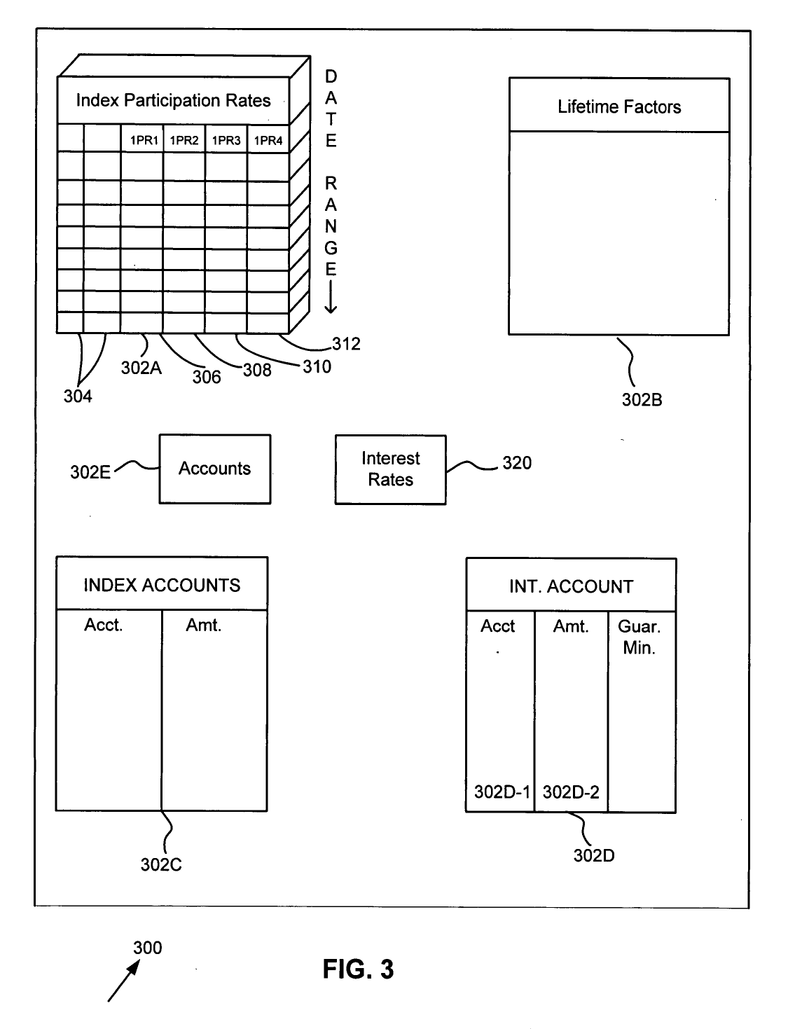

Turning to FIGS. 2 and 3, which will be discussed interactively, the high-level processing flow and an exemplary data structure are shown for a single account or multiple accounts, various steps being omitted for simplification. For purposes of discussion of a practical embodiment, the data structure will be illustrated as a relational database having a suitable number of tables of appropriate configuration. FIG. 3 illustrates such a relational database 300 comprising a collection of tables 302A-302E. However, those skilled in the art of computer science and data processing will appreciate that other data structures may be employed. The one or more processors present within a computer system or network accessing this database (which may be a localized or distributed database), not shown, perform the processing described herein.

Each of tables 302A-302E may be a separate file, or one or more tables may be combined into a single file. Or other database constructs may be employed, instead.

In FIG. 2, an annuity contract as discussed above is formed in Act 202. The contract is formed when signed by both parties (manually or electronically) or otherwise legally acknowledged so as to form a binding commitment, and when the issue premium (or agreed portion thereof) is received by the issuer. Premium receipt can be in any form, including but not limited to receipt of a check, electronic funds transfer, or charge to a credit account.

Index Participation Rate

In this example embodiment, the functional relationship between an index and an account value is that the selected index value is multiplied by a factor to determine (at least in part) the amount to be credited to an account. The factor is called the Index Participation Rate (IPR) (sometimes just referred as a “participation rate”). Thus, to determine account values and benefits, two parameters are foundational: an index value and an applicable Index Participation Rate (IPR) (or other function parameter values used in its stead). A data (file) structure 302A is provided for receiving and retaining a history of IPRs as they are created. The example IPR file structure 302A preferably is very flexible to allow IPRs to be set for a specific class of (one or more) contracts based on common attributes such as issue date(s), policy duration or other characteristics. For example, four participation rates may be used, based on contract duration (i.e., new business vs. renewal) and whether the income benefit has been activated (or, as the term may be used elsewhere herein, elected). Other than as anti-discrimination rules or contract terms might impose, there is no reason, of course, that one could not relate participation rates directly to accounts, allowing each account or groups of accounts to have individualized participation rates. The applicable IPR can be set on a daily basis but it is not necessary to do so; other frequencies may be acceptable. The four participation rates may be used for all accounts, so it is not necessary to store the participation rates multiple times or with each account record. It is simply more efficient to record IPRs once for all accounts though some potential flexibility is lost.

With reference to Index Participation Rate table 302A, one row may be provided for each date range combination. Multiple columns 304 are provided based on a flexible structure of issue age of the Certificate Owner and duration or age of the contract. There are four additional columns for each row. The IPR value IPR1 in column 306 is utilized if the lifetime withdrawal benefit for the account is inactive and the account is in its first year; the IPR value IPR2 in column 308 is utilized if the lifetime withdrawal benefit is active and the account is in its first year; the IPR value IPR3 in column 310 is utilized if the lifetime withdrawal benefit is inactive and the account has gone beyond its first anniversary; and the IPR value IPR4 in column 312 is utilized if the lifetime withdrawal benefit is active and the account has gone thru its first anniversary. Participation rates may be typically effective for one year; after that, depending on the contract, the participation rate selection may be effective at any time specified in the contract, typically either on a fixed calendar date for all contracts or for a group of contracts, or on contract anniversary.

Participation rates are typically “declared” or established at the beginning of the contract year. The date of the contract, duration, and whether the lifetime withdrawal benefit is active or not, is used to reference the corresponding participation rates.

Activating the Lifetime Benefit

Typically, after some minimum age (60, for example), the Certificate Owner can activate the Lifetime Benefit. The Certificate Owner doesn't have to start taking withdrawals at this point, of course, as explained above. Once the Lifetime Benefit has been activated, the system calculates the periodic lifetime income amount. This amount may be calculated by multiplying the Lifetime Factor (from data structure or table 302B) by the greater of contract value or minimum guaranteed value. The Lifetime Factor is based on the covered person's age and gender and/or other predetermined attributes. Contract value is the value of the Index Account from table 302C plus the value of any Interest Accounts from table 302D.

The minimum guarantee value is set to the sum of all premiums less withdrawals, accumulated at the guarantee rate then in effect.

The Lifetime Withdrawal Balance is now equal to the lifetime income amount.

For each account, to maintain account values the system asks whether the Lifetime Benefit has been activated, Act 206. The answer to this question determines which participation rate applies to the account, IPR1 or IPR3 versus IPR2 or IPR4. An affirmative answer selects IPR2 or IPR4 (Act 208A) and a negative a negative answer selects IPR1 or IPR3 (Act 208B). Once the change in the index has been determined, a test is performed (Act 210) to determine whether its value is positive. If so, the appropriate IPR itself is used (Act 212) to calculate the Index Credit and if not, the Index Credit is set to zero. Then the Benefit Value is updated, Act 216.

If the Lifetime Benefit has been activated, the Lifetime Withdrawal Balance is updated, Act 218. If any portion of the annual income is not withdrawn, it is carried forward and accumulated in the Lifetime Withdrawal Balance. If a withdrawal is taken which exceeds the Lifetime Withdrawal Balance, the lifetime income amount is reduced.

Once Acts 216 and 218 are completed, control reverts to Act 204 for the next year's processing.

These actions are processed on each contract anniversary (or at another agreed interval).

The renewal participation rate set in one year preferably is used at the next anniversary as the participation rate for the next year. It may be a function of one or more factors of interest. For example, the renewal participation rates might be a function of the age of the annuity contract. If this is done, the illustrated Participation Rate table 302A obviously is insufficient and additional fields, tables or files are required.

If the Participation Rate table 302A is expanded, to permit multiple entries for one or more of IPR1-IPR4 daily, and/or multiple participation rates dependent on a policy age or other variable(s), greater flexibility is possible. With the addition of another table or pointing mechanism, each account or group of accounts can be assigned its own participation rate profile. Thus, as much flexibility as desired can readily be provided for changing rates at any time and for setting different rates for different participants for any given date/time.

Another parameter that may be stored is the relevant interest rates. These include any minimum guaranteed interest rates, if applicable, and any applicable fixed interest rates. (The guaranteed interest rate is credited on all premiums paid, less any withdrawals taken. Any amount guarantees based on the minimum guaranteed interest rate declared at the issuance of the annuity agreement is called the “Guaranteed Minimum Value.”) If the system is to support a variety of annuity contracts of the type discussed above, some may be based on fixed rate returns from appropriate instruments, and such fixed rates may be recorded in a table 320. Table 320 may also store other applicable interest rates. Only current rates may be stored or, preferably, a complete interest rate history may be stored, on a global or per-account or account group basis.

Another table, 302B, may be used to store Lifetime Benefit factors. These factors may be based on age and gender, and possibly other factors. Rates may vary with gender or they may be gender neutral.

In addition to retaining parametric information, tables may be provided for storing account data—including, for example, index account values, benefit values, lifetime withdrawal values, etc.

Index Account table 302C is used to store earnings based on the agreed index and a selected current participation rate. Although other approaches may be used, it is assumed that earnings are credited to the index account once each year, at each contract's anniversary (with an exception most likely being made for a credit calculation and addition at the death of the annuitant). A crediting method must be selected to account for anniversaries falling on weekends and holidays.

As index values typically will change during the course of a day, it is probably preferable to employ, for all calculation purposes herein, rather than an up-to-the-minute current index value, the value of the index at the close of the immediately prior business day. Of course, other conventions may be adopted. Use of the prior day's closing value is simple and it ensures that there is no unintended discrimination among accounts.

An Interest Account and corresponding Interest Account Table 302D also may be provided. (The Interest Account may be considered the amount or amounts (if there are multiple credits to the account at different times) in column 302D-2 for an account or contract 302D-1). Interest rates used for determining interest to be added to the account are pulled from Interest Rate table 320. In some embodiments, payments made by a customer entity to an issuer during a year are accumulated in the Interest Account and bear interest at a predetermined rate, until the next anniversary of the agreement (or other agreed date), at which point the amount in the Interest Account (principal plus interest) is moved into the Index Account. This simplifies management of the Index Account as funds in the Index Account are all in the account for an entire year (or other agreed term). Preferably, earnings for the Interest Account are based on a fixed rate set at the issue date of the annuity agreement, and reset on its anniversary dates. The amounts in the Interest Account earn interest only for the periods they are in the Interest Account.

Often, an annuity contract will provide for a guaranteed minimum interest rate, and that is also possible in the illustrated example. An entry 342 is provided in the interest table for receiving a guaranteed minimum interest rate when the issuer and entity purchasing the annuity establish their agreement, along with an indication of those agreements to which the minimum interest rate applies; the latter may be indicated by effective date of the agreements or some other criteria, such as contract number. Prior to applying an interest rate to the principal in the Interest Account, the guaranteed minimum interest rate is checked and this rate is used if it is larger than the rate that otherwise would apply. If there were withdrawals during the period interest is to be calculated, it may be necessary, depending on the contract language, to compute interest daily on the balance in the Interest Account or, to avoid compounding, to simply apply the interest rate separately to the withdrawals and adjust the total interest credit accordingly.

In each of the numerous annuity accounts, a variety of transactions/events may occur on any given day. These may include, without limitation, payments, withdrawals, participation rate changes, and interest rate changes, in addition to address changes, beneficiary changes, and a variety of other transactions and events. Some of these actions or changes, and attendant calculations, need to be performed in a known order in order to maintain data integrity and consistency. Hence, there may be a considerable amount of calculation and database updating required on a daily basis. Additionally, some processing will only be needed on specific dates, such as account anniversaries (which may be the actual anniversary or a surrogate date, such as a day earlier or later). Performing these actions efficiently is important, both as a cost containment measure and to ensure that the processing can be done in the time available. To achieve consistency and to minimize processing, it is desirable to enter the data asynchronously, as it becomes available, but to do the processing of new and changed data on a batch basis, after regular business hours, in a predetermined sequence.

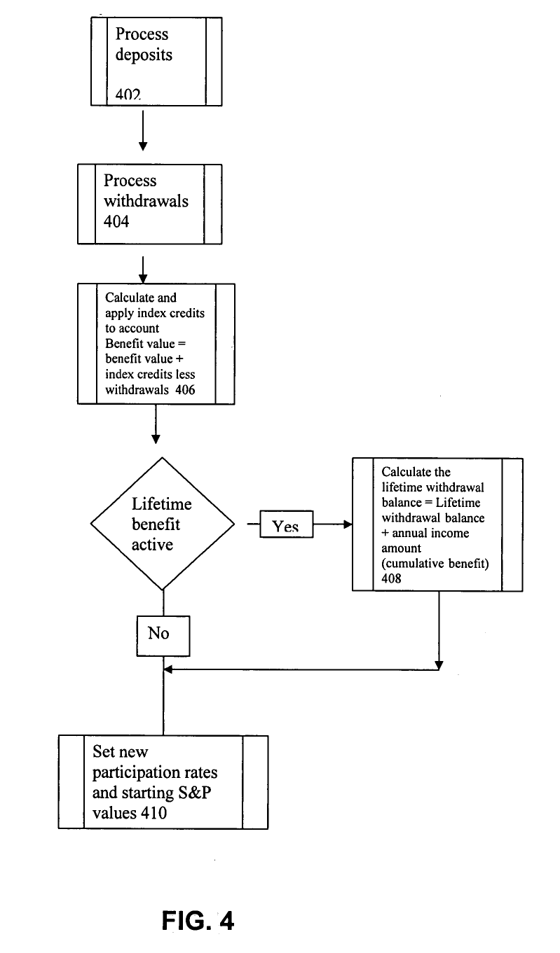

A typical order of processing includes an initial determination, for each annuity, as to whether the day is (actually, was) an anniversary day or a non-anniversary day. Thus, the processor steps through the account table 302E and makes this determination for each entry. If the account is determined to have encountered an anniversary, then the anniversary processing of FIG. 4 is invoked. In Act 402, the deposits received that day are processed, followed by Act 404, in which the withdrawals made that day are processed. Next, in Act 406 the Index Credits are calculated and applied to the relevant Index Account for the entity. Then (if the Lifetime Benefit is active) the Lifetime Income Amount is added to the Lifetime Withdrawal Balance for the annuity to yield a new Lifetime Withdrawal Balance amount, Act 408. This is done whether the entire annual amount has been withdrawn, a portion of the annual amount has been withdrawn, or no withdrawals had been taken that year. In the next step, Act 410, the Participation Rates for the Index Account are determined for the coming year, and the starting index value for the next year is set and stored.

On both anniversaries and non-anniversaries, interest is added, payments may be made to the Interest Account and withdrawals may be taken from that account. On anniversaries or other defined times, amounts in the Interest Account are transferred into the Index Account.

With respect to the Lifetime Benefit, if included in a particular embodiment, it is preferable that either in a data structure (e.g., table or file) containing general contract information, or in one or more separate data structures, certain relevant information be stored. Such information may include, for example: the status of the benefit (i.e., activated, deactivated or not yet activated); the identity of the covered life; the Lifetime Benefit Factor (LBF) read from a Factor File or Table (using attained age and sex, for example, as selectors); the attained age of the covered person when the Lifetime Benefit is first elected; the current LBF that would be used in calculating the Lifetime Benefit were the premium received on the current day; the current age of the covered person; contract value and minimum guaranteed contract value; election date; Lifetime Income; Lifetime Income Withdrawal Balance; and the amount of Lifetime Income withdrawals taken in the current contract year and cumulatively.

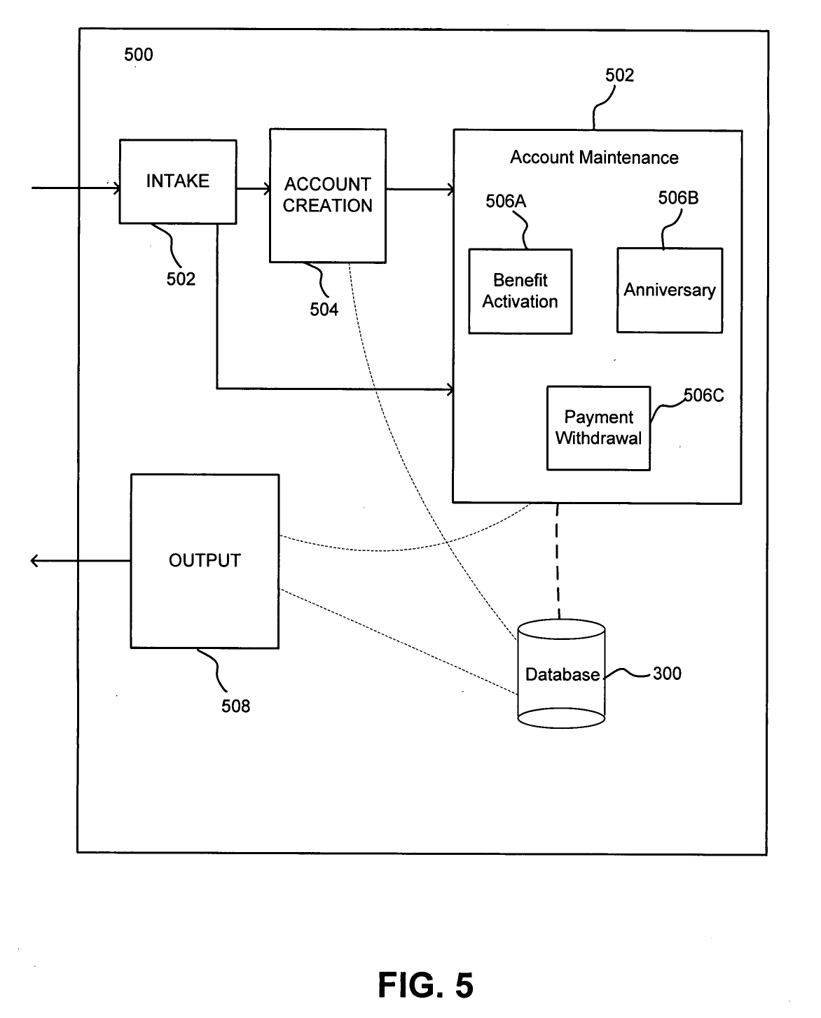

Turning to FIG. 5, there is shown a system 500 which (in addition to the system of FIG. 1) is suitable for use in connection with the data structure 300 for establishing and maintaining investment accounts of the equity indexed annuity variety discussed above, and variations for other types of investment accounts will be discussed, also. System 500 comprises a collection of processing modules 502—with access to data structure 300 as needed (express connection not being illustrated to avoid unnecessarily complicating the diagram). An Intake Module 502 receives input about an investment product to be administered for the benefit of a customer of an issuer. Using the input data supplied (at Data In, via keyboard, optical character reading, electronic data feed or other mechanism), Account Creation module 504 creates a new account record in data structure 300, suitable to the type of investment product. The system may be designed to manage multiple types of investment products as discussed above, or only a single type. For purposes of illustration, the administration of an equity indexed annuity product is specifically illustrated; with minor changes, the system may be adapted to other kinds of products. Once the necessary table or file entries are created by Account Creation module 504, Account Maintenance module 506 takes over. Account maintenance may require some external inputs (e.g., activation of benefits, recording receipt of payments, etc., so a connection is shown between modules 502 and 504. For an equity indexed annuity product, Account Maintenance Module 506 may include submodules 506A, 506B, and 506C and other appropriate submodules. For example, module 506A may be a Benefit Activation module which, responsive to activation of the Lifetime Benefit, later selects an appropriate IPR for use in updating the Index Account at a next update event (e.g., anniversary); module 506B may be an anniversary module which performs, by itself or with the aid of other modules, the above-described anniversary processing, and module 506C may be a payment and withdrawal processing module which manages the crediting and interest processing for payments and withdrawals. An output module 508 provides appropriate reports, query responses and finds transfers out of the investment product to a customer or her bank account, for example.

In the case of a variable annuity product, the Account Maintenance module would include other sub-modules for determining additions to and subtractions from account value as a result in changes in the underlying investments. Thus, FIG. 5 is intended to be illustrative and not limiting.

An annuity contract typically provides a number of other clauses. The example annuity contract provided below provides one such collection of terms. It is not intended, however, that this example be limiting. There may—and usually will—be other provisions and administrative actions in an actual annuity agreement (than those discussed above), but these other provisions and administrative actions are not discussed herein, to avoid obfuscating the aspects that are inventive. It will be understood by those skilled in the art that statute, regulation and practice in the insurance and investment industries will dictate additional terms to those discussed herein. Further, alterations, modifications, and improvements are intended to be part of this disclosure, and are intended to be within the spirit and scope of the invention. Those familiar with the fields of investing and annuity contracts will readily perceive terms that may be added, deleted or varied. Accordingly, the invention is intended to be limited only as required by the following claims and equivalents thereto.

To briefly reiterate, embodiments of the product, system and method explained above may provide a guaranteed lifetime income stream while leaving the Certificate Owner free to (1) make additional payments at any time, (2) take withdrawals at any time after the first contract year, (3) surrender the contract at any time for its cash surrender value and/or (4) pay a death benefit. In addition, a guarantee may be provided that investment earnings will never be negative and that payments and investment earnings will never lose value on a year-to-year basis as of anniversary dates.

The Lifetime Benefit has a cost to the Certificate holder. However, in the described embodiments the Certificate Holder does not pay in advance for this benefit, but only once the benefit is activated (i.e., the election is made to receive payments). Moreover, there is no explicit charge unrelated to investment performance. The charge preferably has a floor—preferably zero—which is invoked if the index declines year-to-year more than some amount (which could be zero or some other amount), so there is only a charge for the benefit in those years in which the index (or an investment measure) gains. The charge may be in the form of a differential in the IPR, as illustrated, but it also may take other forms, including an express charge related to mortality considerations or other factors characteristic of the Certificate Owner or another person, a charge dependent on account size, a charge dependent on payment size, Lifetime Income Amount, Lifetime Withdrawal Benefit, a volatility measurement of the underlying investments, or other factors. The charge may be implicit, as in the case of a differential in the IPR providing the funds to cover the issuer's overhead and profit, or explicit, as in a charge dependent on Lifetime Income Amount or account value of other account-related parameter, for example.

Some aspects of the invention may be practiced in investment products other than annuities, including products in which mortality risk is not in issue.

### EXAMPLES (SPECIMENS)

Three example products, or relevant portions thereof, are now provided to illustrate aspects of the invention as applied to an equity indexed annuity product (Example A), and a variable annuity product (Examples B and C). All numbers are for illustration purposes only. These example, or specimen, documents may lack certain content of a commercial product, to simplify the presentation. These examples supplement the discussion above and are part of this disclosure, but it should be understood that not all of the provisions of the examples are required by the invention and its various aspects. An investment product lacking various of these terms may still fall within the claims set forth below, which define the extent of the invention in its several aspects

### Example A

### Issuer Company Information—Name, Address, etc.

In this certificate, “you” or “your” will refer to the owner of this certificate and “we”, “us” or “our” will refer to [Company Name]

If this certificate is in force on the annuity date, we will begin making income payments to the annuitant. We will make payments subject to the terms of this certificate.

Right to Cancel—You may return this certificate to us at the mailing address shown above or to the agent from whom it was purchased for cancellation. You must mail or deliver it within 30 days from the issue date or 20 days after you receive it, whichever is later. This certificate will then be treated as if we had never issued it and we will promptly refund all premiums you have paid and not previously withdrawn.

This is a legal contract between you and us.

[Signature(s) for the Issuer]

Read This Certificate Carefully

Group Deferred Index-Linked Fixed Annuity Certificate

Flexible Premium

Nonparticipating—No Dividends

WE GUARANTEE A MINIMUM AMOUNT PAYABLE ON ALL BENEFITS IN THIS CERTIFICATE. THE ACTUAL BENEFIT PAYMENT AMOUNT MAY BE HIGHER BASED ON INDEX CREDITS DESCRIBED IN THE CERTIFICATE VALUE PROVISIONS. WHILE INDEX CREDITS ARE BASED ON AN EXTERNAL INDEX, THIS CERTIFICATE DOES NOT DIRECTLY PARTICIPATE IN ANY STOCK OR EQUITY INVESTMENTS.

1. Certificate Specifications

Group Contract Owner: [xxxxxxxxxxxxxxxxxx]

Group Contract Number: [yyyyyyyyyyyyyyyyy]

Certificate Number: [1234]

Certificate Type: [Qualified][Non Qualified]

Primary Owner/Age: [John Doe]/[60]

Annuitant/Age [John Doe]/[60]

Primary Beneficiary (Relationship): [Jim Doe (Child)]

Issue State: [Delaware]

Issue Date: [Jun. 01, 2006]

Annuity Date: (1) [Jun. 01, 2041]

Issue Premium: [$50,000]

Index Value at Issue: (2) [1,200.00]

Index Participation Rate: (3) [75%]

when the Lifetime Benefit is exercised: [65%]

[Interest Account Rate: (4) [2.5%]]

Guaranteed Minimum Interest Rate: (5) [1.5%]

(1)Mandatory Annuity Date is the 1st day of the calendar month following the later of the 95th birthday of the annuitant and the end of the 10th certificate year.

(2)The Index Value in this certificate refers to the Standard & Poor's Composite Stock Price 500 Index (“S&P 500 Index”). This index does not include dividends. “Standard & Poor's®”, “S&P®”, “S&P 500®”, Standard & Poor's 500®” are trademarks of The McGraw-Hill Companies, Inc. and have been licensed for use by us. This product is not sponsored, endorsed, sold or promoted by Standard & Poor's and Standard & Poor's makes no representation regarding the advisability of purchasing this product.

(3)The index participation rates are guaranteed for the 1st certificate year. At the beginning of each certificate year thereafter, we will declare new index participation rates and these will be guaranteed for that certificate year. The index participation rates will be shown on the report we send you at the beginning of each certificate year.

(4)The interest account rate is guaranteed for the 1st certificate year. At the beginning of each certificate year thereafter, we will declare a new interest account rate and this rate will be guaranteed for that certificate year. We guarantee that the declared interest account rate will never be less than 1.5% per year. The interest account rate will be shown on the report we send you at the beginning of each certificate year.

(5) The guaranteed minimum interest rate is guaranteed for the lifetime of this certificate and will be increased as necessary to ensure all benefits provided for in this certificate are no less than the minimum values required by any law of the jurisdiction where this certificate was delivered.

Lifetime Factor: The lifetime factor is used to determine the lifetime income at the time lifetime is exercised. The attained age refers to the age of the person covered under this benefit.

| | Attained Age | | | | | |
|---|---|---|---|---|---|---|
| | 60 | 65 | 70 | 75 | 80 | 85 or older |
| Lifetime | [4.0%] | [5.0%] | [6.0%] | [7.0%] | [7.5%] | [8.0%] |
| Factor | | | | | | |

Linear interpolation is used to determine the lifetime factor for attained ages between those shown in the table. For example, the lifetime factor for age 67 is [5.4%].

Surrender Charge: At the time of each withdrawal from the account value, a surrender charge is imposed as a percentage of the amount being withdrawn in excess of the free withdrawal amount defined below. At the time of a total surrender, a surrender charge is imposed as a percentage of the benefit value in excess of the free withdrawal amount.

| | Certificate Year | | | | | | | | | |
|---|---|---|---|---|---|---|---|---|---|---|
| | 1 | 2 | 3 | 4 | 5 | 6 | [7] | [8] | [9] | [10] |
| Surrender | 8% | 8% | 7% | 6% | 3% | 0% | 0% | 0% | 0% | 0% |
| Charge | | | | | | | | | | |

No surrender charge is imposed after [6] completed certificate years.

Free Withdrawal Amount: No surrender charge is imposed on the portion of the withdrawal or surrender benefit not exceeding the free withdrawal amount, defined as the greater of:

(a) starting in the 2nd certificate year, [10%] of the account value at the beginning of the certificate year, less any prior withdrawals during that certificate year;

(b) any lifetime withdrawal balance; and

(c) any Required Minimum Distributions for this certificate.

Minimum Surrender Values: Upon surrender, you are guaranteed to receive no less than the minimum surrender values shown below, per $10,000 of issue premium.

[A table of Minimum Surrender Values is inserted here]

The minimum surrender values shown assume:
all of the issue premium is received on the issue date;
no additional premium and no withdrawal is ever made;
the guaranteed minimum interest rate of [1.5%] per year continues indefinitely; and
the surrender charge is on the total surrender value less the free withdrawal amount.

Upon written request, we will send you the minimum surrender values for your issue premium.

2. Definitions

“issue date”—The date this certificate is issued and your rights and benefits begin. The issue date is shown on the Certificate Specifications Page.

“certificate year”—The first certificate year starts on the issue date. Future certificate years start on the same month and day in each subsequent year.

“certificate month”—During a certificate year, the first certificate month starts at the beginning of the certificate year and subsequent certificate months start on the same day in each subsequent month. There are 12 certificate months in each certificate year.

“written notice”—Any written notice required under this certificate. Such notice by you must be signed by all owners and delivered to us at our home office, unless we inform you otherwise. Any required written notice by the annuitant must be signed by the annuitant and delivered to us at our home office, unless we inform the annuitant otherwise. Such notice by us will be sent to you at the last known address on our records. You must notify us of any address changes. We are not liable for any action taken by us prior to our receipt of written notice.

“Required Minimum Distribution”—If this certificate is qualified, the Internal Revenue Service generally requires that you begin receiving payments from this certificate starting in the calendar year you reach 70½. The minimum amount of these payments is known as Required Minimum Distribution. You must notify us by written notice when you make a withdrawal to meet your Required Minimum Distribution.

3. Certificate Value Provisions

The Certificate Specifications Page displays the issue premium, index participation rate, index value, interest account rate and the guaranteed minimum interest rate referenced in this section.

Premium

The issue premium is due on the issue date of this certificate and must be received by us in order for this certificate to be valid. Premiums must be paid in United States currency.

The issue premium is allocated to the index account. If your application indicates that the issue premium is to be paid in installments, payments received prior to the end of the third certificate month are allocated to the index account, otherwise they are allocated to the interest account.

Subject to our administrative rules in effect at the time, you may pay additional premiums at any time prior to the annuity date. During a certificate year, additional premiums received prior to the end of the first certificate month are allocated to the index account, otherwise they are allocated to the interest account. We will not accept premiums once a death benefit becomes payable unless this certificate is continued under the Spousal Continuation provision.

Account Value

The account value is at all times the index account plus the interest account.

1. Index Account—its balance equals:

(a) premiums allocated to the index account; less

(b) withdrawals from the index account; plus

(c) index credits; plus

(d) transfers from the interest account.

Index Credit—is added to the index account at the end of each certificate year and equals the balance of the index account as of that date, multiplied by the greater of zero and:

(a) the index participation rate, times

(b) the excess of (ii) over (i), divided by (i), where

(i) is the index value at the beginning of the certificate year; and

(ii) is the average of the twelve index values as of the end of each certificate month during that certificate year.

Partial Index Credit—may be added to the index account at the time a benefit is due, depending on the type of benefit as explained in the Certificate Benefit Provisions. If the benefit becomes payable prior to the end of the first certificate month of the certificate year, then the partial index credit is equal to zero. Otherwise a partial index credit is determined in exactly the same manner as the index credit described above except that (b)(ii) is the average of the index values as of the end of each certificate month during that certificate year on or prior to the date the benefit becomes payable.

2. Interest Account—its balance equals:

(a) premiums allocated to the interest account; less

(b) withdrawals and transfers from the interest account; with both (a) and (b) accumulated at

(c) the interest account rate.

Withdrawals during a certificate year are taken from the interest account first until it is fully depleted and then from the index account.

Any balance in the interest account will be transferred to the index account at the end of each certificate year, after index credits have been added to the index account.

Guaranteed Minimum Value

The guaranteed minimum value is at all times equal to premiums received less any withdrawals made, with both accumulated at the guaranteed minimum interest rate.

Benefit Value

The benefit value is the greater of the account value and guaranteed minimum value.

4. Certificate Benefit Provisions

This certificate provides for the payment of four different types of benefits: (a) surrender benefits; (b) death benefits; (c) lifetime benefits; and (d) annuity benefits. Once a benefit becomes payable, all other benefits expire. The only exception is when a death benefit becomes payable and the designated beneficiary chooses to continue this certificate by either Spousal Continuation or Non-Spousal Continuation. See the Certificate Continuation provisions.

Surrender Benefits

This section applies before the annuity date. The Certificate Specifications Page displays the surrender charge that may apply on surrender and/or withdrawal.

Surrender

You may surrender this certificate by written notice for its surrender value. The surrender value is the benefit value less any applicable surrender charge. Once the surrender value is paid, this certificate is no longer in force.

The surrender value is paid to you in a lump sum unless you request that it be paid to you under a settlement option. See the Annuity Payment Options section.

Withdrawal You may request a withdrawal from this certificate by written notice. The minimum withdrawal you can take is $500 and unless you have exercised the lifetime benefit, the remaining account value after the withdrawal must be no less than $4000. Any applicable surrender charge will be deducted from the withdrawal amount and you will receive the balance.

Deferral

We may defer payments of a withdrawal or surrender for up to six months from the date of your request. We will inform you by written notice of any delay.

Waiver

When you request a withdrawal or surrender of this certificate, you may also request that we waive any surrender charge thereon, provided

(a) the covered person is confined in a hospital and/or nursing facility;

(b)the covered person is receiving at least intermediate nursing care; and

(c)the confinement is for at least 45 days during any 60 day period that begins after the first certificate year.

The covered person is the primary owner or the annuitant if you are a non-natural owner.

Your request for waiver of surrender charges must be accompanied by documentation that all qualifications have been met. You must submit proof of confinement by means of a document prepared by the applicable hospital and/or nursing facility and any other reasonable information we may request to properly evaluate the claim. The request for waiver of surrender charges must be filed with us no later than 91 days after the end of the confinement. If we determine that not all qualifications under this provision were met, we will give you the choice to cancel your request for withdrawal or surrender or continue to have it process without waiver of surrender charges.

“Hospital” means a facility or a part of one that is licensed as a hospital (if the hospital is located in a state that requires licensing) and operates pursuant to law.

“Nursing facility” means (a) a facility or part of one that is state-licensed as a skilled nursing facility or an intermediate care facility, if the facility is located in a state requiring licensure; (b) provides nursing care for 24 hours a day which is supervised by a registered nurse, licensed practical nurse, or licensed vocational nurse; and (c) has at least one registered nurse on duty for 8 hours a day.

“Intermediate nursing care” means regular nursing and/or rehabilitative care furnished on a physician's written order that requires the skills of technical or professional persons such as nurses or physical therapists. It does not mean custodial care, which is care that can be given by a person without professional skills or training.

Death Benefits

Death Benefit Amount

The amount paid as a death benefit is the benefit value. Partial index credits will be added to the index account on the date of death, unless this certificate is continued under the Spousal Continuation provision.

Death of Owner

If any owner dies before the annuity date, we will pay the death benefit amount to the designated beneficiary defined as:

(a) any surviving owner, if living; otherwise

(b) the primary beneficiary, if living; otherwise

(c) the contingent beneficiary, if living; otherwise

(d) the estate of the deceased owner.

The designated beneficiary will become the new owner and may elect to receive the death benefit amount in a lump sum or continue this certificate under the Certificate Continuation provisions below. If this certificate is continued, all future surrender charges are waived.

Death of Annuitant

If you are a non-natural owner and the annuitant dies, then the Death of Owner provision above will apply with the annuitant being treated as the deceased owner. In all other cases, the death of the annuitant will not cause the death benefit to be payable and this certificate will continue with a new annuitant, either a living contingent annuitant or, if none, the primary owner.

Certificate Continuation

Spousal Continuation is permitted when the sole designated beneficiary is the spouse of the deceased owner. This certificate will continue without any modifications except that if the deceased owner was the annuitant then the new annuitant will be the living contingent annuitant or, if none, the spouse. The mandatory annuity date will not change unless the spouse becomes the annuitant. In that case, the new mandatory annuity date will be the later of the existing mandatory annuity date and that based on the spouse's date of birth.

Spousal Continuation can be applied only once throughout the lifetime of this certificate.

Non-Spousal Continuation is available in all other cases. This certificate can be continued for up to five years from the date of death but the Death Benefits, Lifetime Benefits and Annuity Benefits provisions will no longer apply. The contract year will be deemed to end on the date of death and a new contract year will immediate start from that point on.

Within one year from the date of death, the designated beneficiary can take his/her share of the then current benefit value in a lump sum or have it paid under a settlement option. See the Annuity Payment Options section. Payments under a settlement option must be over the life of that person or for a period not exceeding his/her life expectancy.

If this certificate is continued until the end of the five year period, we will automatically pay the designated beneficiary's share of the benefit value to the designated beneficiary if living, otherwise to the person named by the designated beneficiary by written notice or to the designated beneficiary's estate if no one was named.

Lifetime Benefits

The Certificate Specifications Page displays the lifetime factors referenced in this section.

Exercising the Lifetime Benefit

The lifetime benefit may be exercised before the annuity date. Once exercised, the lifetime benefit provides two distinct benefits:

(a)we will waive any surrender charge on withdrawals from the account value provided the withdrawals do not exceed the lifetime withdrawal balance; and

(b)should a withdrawal not exceeding the lifetime withdrawal balance (or any Required Minimum Distribution if higher) cause the account value to be fully depleted, we will start paying the lifetime income every year for as long as the person covered under this benefit lives.

You may exercise the lifetime benefit by written notice at any time provided the account value is no less than $12,500 and the person covered under this benefit is 60 years or older. Your written notice must indicate whether you or the annuitant is to be covered under this benefit. Once you have exercised the lifetime benefit, future index credits will be based on the index participation rate applicable when the lifetime benefit is exercised.

The lifetime benefit can only be terminated if the person covered under this benefit dies, in which case: (a) the lifetime income is set to zero, (b) the lifetime withdrawal balance is maintained and (c) subsequent index credits will be based on the index participation rate applicable when the lifetime benefit is not exercised. Once terminated, you cannot reinstate the lifetime benefit, unless this certificate is continued under the Spousal Continuation provision. We reserve the right to terminate the lifetime benefit if this certificate is assigned.

The Lifetime Income

On the date you exercise the lifetime benefit, we will determine the lifetime income. The lifetime income is the benefit value multiplied by the lifetime factor based on the then attained age of the person covered under this benefit.

The account value can only fall to zero when you make a withdrawal. If the account value is zero, this certificate is no longer in force. You have the choice of:

(a) surrendering this certificate for its surrender value if any; or

(b) having the then current lifetime income paid to the person covered under this benefit at the end of each certificate year for as long as this person lives.

We will not pay the lifetime income every year if this amount is less than $250. Instead, we will pay a lump sum equal to the lifetime income divided by the lifetime factor based on the then attained age of the person covered under this benefit.

The Lifetime Withdrawal Balance

The lifetime withdrawal balance keeps track of the maximum amount you can withdraw without incurring a surrender charge and without affecting the lifetime income. It equals the lifetime income on the date the lifetime benefit is exercised and is:

(a) reduced by any withdrawals;

(b) increased by the amount of the lifetime income at the end of each certificate year; and

(c) increased by any increase of the lifetime income when a premium is received.

Mandatory Withdrawals

You must withdraw an amount of no less than the lifetime income amount by the end of each certificate year following the mandatory annuity date.

Changes to the Lifetime Income

The lifetime income will be increased if a premium is received after the lifetime benefit has been exercised. The increase equals the premium multiplied by the lifetime factor based on the then attained age of the person covered under this benefit.

The lifetime income will be reduced if a withdrawal exceeds the lifetime withdrawal balance or any Required Minimum Distribution, if higher. The new lifetime income is the lifetime income prior to the withdrawal multiplied by the ratio of (a) the account value after the withdrawal; over (b) the account value less the lifetime withdrawal balance, immediately prior to the withdrawal.

Annuity Benefits

Annuity Benefit and Annuity Payments

The amount applied to determine annuity payments is the benefit value. Partial index credits will be added to the index account on the annuity date if this date is also the mandatory annuity date.

If the annuitant is alive on the annuity date, payments to the annuitant will begin under the Annuity Payment Option chosen.

You may change the Annuity Payment Option at any time by written notice at least 30 days prior to the annuity date. Unless you choose otherwise, payments will automatically be based on Option B: Life Income with 10 Years Guaranteed.

Annuity Date

Unless otherwise specified by you in the application, the annuity date is automatically the mandatory annuity date. The mandatory annuity date is shown on the Certificate Specifications Page and can only be changed in accordance to the Spousal Continuation provision in the Death Benefit section.

You may change the annuity date by written notice at least 30 days prior to the existing annuity date provided the new annuity date is: (a) after the end of the first certificate year; (b) no later than the mandatory annuity date; and (c) falls on the first day of a calendar month.

5. General Provisions

Certificate

This certificate form and any attached copy of the application, any riders and endorsements make up the entire certificate. Only our President or Secretary may agree to change any of the terms of this certificate. Any changes must be made in writing and with your consent, unless provided otherwise by this certificate.

So that this certificate will maintain its status as an annuity under the Internal Revenue Code, we reserve the right to change this certificate to comply with future changes in the Internal Revenue Code, any regulations or rulings issued under that Code, and any requirements otherwise imposed by the Internal Revenue Service. You will be sent a copy of any such amendment as well as a copy of the regulatory change requiring the amendment.

Ownership Provisions

The primary owner and any joint owner are named in the application. They may be changed by you. If you change an owner who is also the annuitant, the owner being changed will continue as the annuitant. The primary owner and any joint owner own this certificate equally with right of survivorship.

You may exercise all the rights of this certificate while it is in force, subject to the rights of any assignee under an assignment filed with us.

Annuitant Provisions

The annuitant is named in the application and shown on the Certificate Specifications Page. You cannot change the annuitant. If the annuitant dies, the new annuitant will be determined in accordance with to the Death Benefits section.

Beneficiary Provisions

The primary beneficiary is named in the application and shown on the Certificate Specifications Page and may be changed by you.

If you name more than one primary beneficiary and do not state otherwise, any non-surviving primary beneficiaries will not receive any benefit. The surviving primary beneficiaries will receive equal shares, and if there is only one survivor, that person will receive the entire benefit. If no primary beneficiary is alive, the contingent beneficiary will receive the benefit. If you name more than one contingent beneficiary, the rules stated above for multiple primary beneficiaries will apply.

Change of Owner, Beneficiary, or Contingent Annuitant

While this certificate is in force, you may by written notice change the primary owner, joint owner, primary beneficiary, contingent beneficiary or contingent annuitant. An irrevocably-named person may be changed only with the written consent of that person. After we record the request, the change will take effect as of the date you sign the request. The change will not affect any payments we make or actions we take before we record the request.

Assignment

You may assign this certificate at any time while it is in force. The assignment must be in writing and a copy must be received at our office. Your rights will be subject to the assignment. An assignment will not affect any payments we make or actions we take before we record it. We are not responsible for the validity of any assignment.

Incontestability

We will not contest this certificate.

Nonparticipating in Surplus

We will not pay any dividend on this certificate.

Certificate Settlement

All amounts due under this certificate will be paid from our office in United States currency.

Protection of Proceeds

No beneficiary or annuitant may commute or assign any payments under this certificate before they are due. To the extent permitted by law, no payments shall be subject to the debts of any beneficiary or annuitant or to any judicial process for payment of those debts.

Misstatement of Age or Sex

If age or sex used to determine the annuity payments or the lifetime income has been misstated, we will compute that amount payable based on the correct age and sex. If the amount payable has started, any underpayments that may have been made will be paid in full with the next correct amount payable. Any overpayment, unless repaid to us in one sum, will be deducted from future amounts payable otherwise due until we are repaid in full.

Evidence of Death, Age, Sex or Survival

If a certificate provision relates to the death of a person, we will require proof of death before we act under that provision. We will accept a certified death certificate or a certified decree of a court of competent jurisdiction as to a finding of death. We will also accept any other document which is considered due proof of death under applicable state law. If our action under a certificate provision is based on the age, sex or survival of any person, we may require evidence of that fact before we act under that provision.

Taxes

Any premium taxes or other taxes levied by any governmental authority with respect to this certificate will be deduced from your premiums or the benefit value when incurred or, at our option, at a later time. If such taxes are deducted from your premiums, any reference in the Certificate Value provisions to a premium amount means the net premium amount after such deduction. We will also deduct from any amount payable under this certificate any income taxes a governmental authority requires us to withhold with respect to that amount.

Change of Index

We will inform you by written notice if we substitute the external index on which the index values in this certificate are based. We will only substitute the external index if it is discontinued or its calculation is substantially changed. Any substitution by us needs to be approved by the appropriate insurance supervisory official.

Reports

We will send you a confirmation statement every time we receive your premium. Shortly after the end of each certificate year, we will send you a report that shows the account value and benefit value as of the beginning and end of the certificate year, together with any increase due to premiums received, index credits and interest credits as well as any decrease due to withdrawals. This report will also show the lifetime income and lifetime withdrawal balance as of the end of the certificate year if you have exercised the lifetime benefit. We will send you any other reports that may be required by law.

6. Annuity Payment Options

The payee is the person who receives the regular payments. Prior to the annuity date, the payee is the person who is entitled to a benefit payment but chooses to receive regular payments instead of a lump sum. On the annuity date, the annuitant is the payee and the amount of regular payments is based on that person's age and gender, even if the annuitant designates someone else to receive the payments.

Regular payments will be made monthly unless the payee chooses by written notice to receive quarterly, semi-annual or annual payments. We reserve the right to reduce the frequency of payments such that the payment is no less than $100. We also reserve the right to pay the amount applied, if less than $2000, in a lump sum rather than in the form of regular payments.

The following annuity payment options are available under this certificate.

Option A—Life Income

We guarantee regular payments for as long as the payee lives. Payments stop when the payee dies.

Option B—Life Income with 5, 10, 15 or 20 Years Guaranteed

We guarantee regular payments for as long as the payee lives. In addition, we guarantee that the successor payee will receive payments for the remainder of the chosen guaranteed period if the payee dies during that guaranteed period. Upon written notice of the successor payee, we will make a lump sum payment equal to the present value of the remaining payments, commuted at the rate used to compute the regular payments.

Option C—Joint and Survivor Income

We guarantee regular payments for as long as the payee and a joint payee live. Upon the first death, we will continue to pay ⅔rd of the regular payment for as long as the other payee lives. Payments stop when the second payee dies.

Option D—Income for a Fixed Number of Years

We guarantee regular payments for a chosen number of years, not fewer than 10 nor more than 30. If the payee dies before the last payment is made, we will continue to make the remaining payments to the successor payee. Upon written notice of the successor payee, we will make a lump sum payment equal to the present value of the remaining payments, commuted at the rate used to compute the regular payments.

Guaranteed Monthly Payments per $1000 Applied

The minimum monthly payment for each $1000 applied under each annuity payment option is given in the Monthly Annuity Payment Rate Table. The payee will receive the higher of these guaranteed minimum payments and those we then currently offer as of the date of the first payment.

The Monthly Annuity Payment Rate Table is based on the minimum guaranteed interest rate of 1.5% per year and the 2000 Individual Annuitant Mortality Table for Options A, B and C. The amount to be received is based on the payee's gender and adjusted age at the time payments are to begin.

For the purpose of this section, adjusted age means the actual age of the payee if payments start before 2010 otherwise the actual age of the payee less 1 year for each 5-year period thereafter. For example, the reduction is 1 year if payments start in years 2010 to 2014, 2 years if payments start in years 2015 to 2019, and so on.

The Monthly Annuity Payment Rate Table shows payment amounts for exact adjusted ages. For adjusted ages not shown in the table, straight line interpolation is used based on the age of the payee measured in complete years and months. The payment amount under an option for any adjusted age(s) not shown in the table will be quoted by us upon request.

Monthly Annuity Payment Rate Table per $1000

[Appropriate Tables are inserted here for each option.]

### Example B

There now follows an example of a so-called “guaranteed withdrawal benefit for life” rider for a variable annuity product which incorporates aspects of the invention:

### XXXXXX Insurance Company

Rider

[INControl Benefit]

This rider (“Rider”) is made part of the Certificate to which it is attached. If elected, the Rider is effective on the Date of Coverage. The Rider may not be elected after the Date of Coverage. Additional Purchase Payments may NOT be made after the [first year] following the Date of Coverage. The Rider may be cancelled at any time. See “Rider Cancellation” below.

Eligibility

The [INControl] Benefit may only be elected if the following eligibility conditions are meet:
The oldest Participant and the oldest Annuitant are both age 85 or younger on the Open Date. (In the case of a non-natural Owner, the oldest Annuitant is age 85 or younger on the Open Date.)
The Participant has not also elected the Earning Enhancement Benefit Premier Plus death benefit rider or any other living benefit rider offered by the Company as of the Date of Coverage.

Definitions

Unless defined below or elsewhere in this Rider, capitalized terms used herein shall have the meanings ascribed to them in the Certificate (including the Certificate Specifications page) to which this Rider is attached.

Account: the Accumulation Account as defined in the Certificate.

Account Value: the Accumulation Account Value as defined in the Certificate.

[INControl] Benefit: a guaranteed withdrawal benefit made available by the Company through this living benefit Rider.

Designated Funds: the variable investment options listed on the Certificate Specifications page under the heading Designated Funds.

[INControl] Annual Amount: the amount added to the [INControl] Balance on each Account Anniversary following the [INControl] Coverage Date; it is equal to [5%] of the [INControl] Benefit Base on the date of crediting.

[INControl] Balance: an account to which the [INControl] Annual Amount is added each year and remains until withdrawn.

[INControl] Benefit Base: the amount used to calculate the [INControl] Annual Amount and the cost for the [INControl] Benefit.

Participant: except as otherwise specifically noted under the “Joint-Life Coverage” section below, as used in this Rider the term “Participant” refers to the oldest Participant of the Certificate; in the case of a non-natural Owner, the term “Participant” refers to the oldest Annuitant.

[INControl] Fee: the fee paid for the [INControl] Benefit. The fee is higher if joint-life coverage is selected. In the event of a “step-up” or “spousal continuation” of the Certificate, the fee may change. See “Step-Up Under the [INControl] Benefit” and “Participants Death under the [INControl] Benefit” below.

[INControl] Coverage Date: the date of the Account Anniversary following the Participant's [55th] birthday, or the Date of Coverage if the Participant is at least age [55] on the Date of Coverage.

The [INControl] Benefit

The [INControl] Benefit guarantees annual withdrawals during the Participant's lifetime, regardless of the investment performance of the Designated Funds, subject to the terms and conditions of this Rider. The amount of the annual withdrawal can be any amount up to the [INControl] Balance. Any unused portion of the [INControl] Balance remains available for future withdrawals. If no withdrawals are made during the first [10 Account Years], the Company will credit the Participant's Account Value with an amount equal to the excess, if any, of total Purchase Payments over the amount of the Account Value at the time of crediting. See [“Tenth-Year] Credit” below.

Determining the [INControl] Benefit Base, the [INControl] Annual Amount and the [INControl] Balance

On the Date of Coverage, the [INControl] Benefit Base is equal to the initial Purchase Payment. Thereafter, the [INControl] Benefit Base is:
adjusted following any withdrawals taken before the Participant reaches age [59½];
adjusted following any withdrawals taken after the Participant reaches age [59½], if such withdrawal is in excess of the [INControl] Balance at the time of the withdrawal;
adjusted by any step-ups as described below under the “Step-Up Under the [INControl] Benefit” section;
increased to the extent the Participant exercises the one-time option to use any amount of the [INControl] Balance, as described below under the “How the [INControl] Benefit Works” section; and
increased by any subsequent Purchase Payments made during the [first year] following the Date of Coverage.

On every Account Anniversary following the [INControl] Coverage Date, the [INControl] Annual Amount equals [5%] of the then [INControl] Benefit Base. On that same date, the [INControl] Balance equals the [INControl] Annual Amount. Thereafter, the [INControl] Balance:
increases by [5%] of any subsequent Purchase Payments made during the [first year] following the Date of Coverage;
increases on each Account Anniversary by the amount of the [INControl] Annual Amount determined on that Anniversary;
decreases by the amount of any withdrawals taken; and
decreases by any amount used in exercising the one-time option to increase the [INControl] Benefit Base.

How the [INControl] Benefit Works

Under the [INControl] Benefit, the Participant may take withdrawals up to the amount of the [INControl] Balance at any time. If the Account Value is reduced to zero, as long as the [INControl] Benefit Base is greater than zero, the Participant will receive an amount equal to the [INControl] Annual Amount every year for the life of the Participant. Although the [INControl] Balance begins accumulating following the [INControl] Coverage Date, the Participant may not begin withdrawing the [INControl] Balance until the Participant reaches at least age [59½] without reducing the [INControl] Benefit Base. The Participant may continue to withdraw the [INControl] Balance until the Annuity Commencement Date.

The [INControl] Balance can be used in two ways:
the Participant can withdraw all or a portion of the [INControl] Balance through partial withdrawals; or
the Participant can use all or a portion of the [INControl] Balance to effect a one-time increase of the [INControl] Benefit Base.

Any unused portion of the [INControl] Balance remains available for future withdrawals.

Withdrawals from the [INControl] Balance can be taken at any time after age [59½] without affecting the [INControl] Benefit Base. If the Participant makes a withdrawal that does not exceed the [INControl] Balance, at any time prior to the Annuity Commencement Date:
the [INControl] Balance will be decreased by the amount withdrawn in that Account Year; and
the withdrawal will not be subject to surrender charges.

The Participant also has the option to use all or a portion of the [INControl] Balance to increase the [INControl] Benefit Base. This option allows the Participant to increase the future [INControl] Annual Amount. This option may be exercised only once and must occur prior to the Annuity Commencement Date and prior to the later of the [tenth] Account Anniversary or the Account Anniversary following the Participant's [65th] birthday. If the Participant elects to use any [INControl] Balance to increase the [INControl] Annual Amount:
the [INControl] Balance will be decreased by the amount used;
the amount of the [INControl] Balance used will be added to the [INControl] Benefit Base; and
the [INControl] Annual Amount will be reset on the next Account Anniversary to equal [5%] of the then [INControl] Benefit Base.

Subsequent to the exercise of this one-time option, the new [INControl] Annual Amount will be added to the [INControl] Balance on each Account Anniversary, unless and until there is another occurrence (as noted in this section) that changes the [INControl] Annual Amount.

As described below under the “Withdrawals Under the [INControl] Benefit” section, if the Account Value falls to zero, the Participant must withdraw the full amount of the [INControl] Balance in a lump sum or exercise the one-time option to increase the [INControl] Annual Amount, provided the Participant is eligible to make such election at that time.

Withdrawals Under the [INControl] Benefit

Starting at age [59½], the Participant may take withdrawals up to the [INControl] Balance without affecting the [INControl] Benefit. These withdrawals will reduce the [INControl] Balance dollar-for-dollar, but will not change the [INControl] Benefit Base. If a withdrawal is taken that exceeds the [INControl] Balance (or the required minimum distribution amount, if higher), the [INControl] Benefit Base will be reset to equal the lesser of:
the [INControl] Benefit Base prior to the withdrawal reduced dollar-for-dollar by the amount of the withdrawal that exceeds the [INControl] Balance (or the yearly required minimum distribution amount, if higher); and
the Account Value after the withdrawal.

The [INControl] Annual Amount will be recalculated based on the reduced [INControl] Benefit Base. In addition, all withdrawals taken before the Participant reaches age [59½] will be treated as excess withdrawals and the [INControl] Benefit Base will be reduced in the same manner stated above for other excess withdrawals.

Withdrawals taken prior to the Participant reaching age [59½] will be subject to surrender charges if they exceed the Certificate's free withdrawal amount. Commencing when the Participant reaches age [59½], withdrawals taken under this Rider will not be subject to withdrawal charges unless they exceed the greatest of the Certificate's free withdrawal amount, the [INControl] Balance, or any required minimum distribution.

If the Account Value is reduced to zero and the [INControl] Benefit Base remains greater than zero, the [INControl] Benefit will continue. However, no subsequent Purchase Payments will be accepted, no death benefit or annuity benefits will be payable, and all benefits under the Certificate, other than the [INControl] Benefit, will terminate. In that year, the Participant must deplete the [INControl] Balance by either:
taking a lump sum withdrawal equal to the full amount of the [INControl] Balance; and/or
if prior to the later of the [tenth] Account Anniversary or the Account Anniversary following the Participant's [65th] birthday, using the remaining amount of the [INControl] Balance to increase the [INControl] Benefit Base (if the Participant has not previously exercised the one-time option).

Each year thereafter, if the Participant has elected single-life coverage, the Participant will receive annual payments equal to the [INControl] Annual Amount as long as the Participant is alive. If the Participant elected joint-life coverage, payments will continue until the death of both spouses. See “Participant's Death under the [INControl] Benefit” section below.

Cost of the [INControl] Benefit

The [INControl] Fee is set forth in the Certificate Specifications page, unless the [INControl] Fee is later modified. See “Step-Up Under the [INControl] Benefit” and “Joint-Life Coverage” sections below. The [INControl] Fee will be made as a specific deduction from the Account Value, taken on the [last valuation day of the Account Quarter, which is defined as a three-month period with the first Account Quarter] beginning on the Date of Coverage. The initial [INControl] Fee will be applied on the [last valuation day at the end of the Account Quarter] following the Date of Coverage. Thereafter, the [INControl] Fee will continue to be deducted until the Annuity Commencement Date, the Account Value declines to zero, or the [INControl] Benefit is cancelled. See “Cancellation of the [INControl] Benefit” below.

[Tenth-Year] Credit

The Account Value may increase if no withdrawals are made during the first [ten] Account Years from the Date of Coverage. On the [tenth] Account Anniversary, provided no prior withdrawals have been made, the Company will credit the Account Value with an amount equal to the excess, if any, of total Purchase Payments, applied [in the first Account Year], over the Participants then Account Value. The [INControl] Benefit Base will not change. The [tenth-year] credit will be allocated on a pro rata basis to all Designated Funds in which the Participant is invested at the time.

Step-Up Under the [INControl] Benefit

On [each Account Anniversary] prior to the maximum Annuity Commencement Date, if the Account Value, less the [INControl] Balance, is greater than the current [INControl] Benefit Base, the Company will step-up the [INControl] Benefit Base to an amount equal to the Account Value less the [INControl] Balance. After the step-up, the [INControl] Annual Amount will be [5%] of the new [INControl] Benefit Base. Upon step-up, the [INControl] Fee may be higher than the current [INControl] Fee as set forth above under “Cost of the [INControl] Benefit.” The step-up will occur automatically unless it would cause the [INControl] Fee to increase, in which case the Company will send notification to the Participant of the option to elect the step-up. The Participant's written consent is required to accept the higher [INControl] Fee and initiate the step-up. The [INControl] Fee will be set by the Company based on current market conditions at the time of any step-up.

A step-up will not be allowed if the Account Value, less the [INControl] Balance, is higher than [$5,000,000]. For purposes of determining the [$5,000,000] limit, the Company reserves the right to aggregate Account Value with the account values of all other variable annuity certificates owned by the Participant that have been issued by XXXX Assurance Company of Canada (U.S.) or its affiliates.

Designated Funds

All Account Value must be invested in one or more of the “Designated Funds” during the entire term of the [INControl] Benefit. The term of the [INControl] Benefit is for life, unless the [INControl] Benefit Base is reduced to zero or the [INControl] Benefit is cancelled as described below under “Cancellation of the [INControl] Benefit.” The application package contains a list of the only Funds, Guarantee Period dollar cost averaging programs, and asset allocation models that currently qualify as “Designated Funds.” The Company reserves the right, in its sole discretion, to change the available Designated Funds on new and existing Certificates without prior notice. Any time there is a change in the Designated Funds, Account Value will remain in the previously available Designated Funds. However, any future transfers or Purchase Payments may only be allocated to the Designated Funds then available. A future transfer or allocation of Purchase Payments to other than a Designated Fund will result in cancellation of this Rider. See “Cancellation of the [INControl] Benefit” below for additional restrictions.

Joint-Life Coverage

The Participant has the option of electing the [INControl] Benefit with single-life coverage or, for a higher [INControl] Fee, with joint-life coverage. Joint-life coverage is available only if the Participant and sole beneficiary are spouses. Joint-life coverage can be elected on an individually-owned Certificate or on a jointly-owned Certificate. Single-life coverage provides an [INControl] Annual Amount until any Participant dies; joint-life coverage provides an [INControl] Annual Amount for as long as either the Participant is alive or the Participant's spouse is alive. If joint-life coverage is elected, the [INControl] Annual Amount will be calculated and begin accumulating on the Account Anniversary following the [55th] birthday of the younger spouse, or on the Date of Coverage if both spouses are at least age [55] on that date. Withdrawals of the [INControl] Balance cannot be taken until the Account Anniversary following the younger spouse attaining age [59½] without reducing the [INControl] Benefit Base.

Either single-life or joint-life coverage must be elected on the Date of Coverage. Once elected, the Participant may not switch between single-life and joint-life coverage. With respect to joint-life coverage, should the Participant's spouse (as of the Date of Coverage) cease to be the sole primary beneficiary under the Certificate for any reason whatsoever, then joint-life coverage will automatically convert to single-life coverage. However, in the event of this conversion the higher [INControl] Fee associated with joint-life coverage will continue to apply.

Cancellation of the [INControl] Benefit

The Participant may cancel the Rider at any time upon notice to the Company. Upon cancellation, all benefits offered under the Rider shall immediately cease and the Rider may not be reinstated.

With respect to the requirement set forth above in the “Designated Funds” section that Account Value at all times be invested in one or more Designated Funds, the Rider automatically will be cancelled under the following circumstances:
if any Purchase Payment is allocated to an investment option other than a Designated Fund; or
if any portion of Account Value maintained in a Designated Fund is transferred into any investment option other than a Designated Fund.

The Rider will be cancelled upon a change of ownership of the Certificate.

Participant's Death under the [INControl] Benefit

If single-life coverage was selected, at the death of any Participant the Rider terminates and the Beneficiary may elect to exercise any of the available options under the Death Benefit provisions of the Certificate. Alternatively, the Beneficiary may elect to receive the [INControl] Balance. If the surviving spouse is the sole Beneficiary and elects to continue the Certificate (“spousal continuation”), the spouse has the additional option of electing to participate in a new Rider on the original Certificate assuming that the [INControl] Benefit is available to new Participants at the time of such election. If the surviving spouse makes such election:
the new Account Value will be the greater of the [INControl] Balance on the original Certificate or the Death Benefit;
the new [INControl] Fee will be set by the Company based on market conditions at the time and may be higher than the current [INControl] Fee;
the new [INControl] Benefit Base will be equal to the Account Value after any Death Benefit has been credited; and
the new [INControl] Balance will be reset to zero.

If joint-life coverage was selected and one of the Participants dies, the [INControl] Benefit will continue, provided that the surviving spouse, as the sole primary beneficiary, continues the Certificate (“spousal continuation”). In such case:
the new Account Value will be equal to the Death Benefit;
the [INControl] Balance will remain unchanged; and
the [INControl] Benefit Base will remain unchanged until the next Account Anniversary when a step-up could apply due to an increase in Account Value. See “Step-Up Under the [INControl] Benefit” above.

At the death of the surviving spouse, the Certificate, including the [INControl] Benefit, terminates.

Annuitization under the [INControl] Benefit

If the Account Value is greater than zero on the Maximum Annuity Commencement Date, the Participant may elect to:
surrender the Certificate and receive the Cash Surrender Value or the [INControl] Balance, if greater; or
annuitize the Account Value under one of the then currently available Annuity Options.

If no election is made, the Company will pay any remaining [INControl] Balance and annuitize the Certificate as a single life annuity with an annualized annuity payment of not less than the [INControl] Annual Amount that would have been payable immediately prior to the Participant attaining age 95.

If the Account Value is equal to zero and the [INControl] Benefit Base is greater than zero on or before the maximum Annuity Commencement Date, then the Participant will receive the full [INControl] Annual Amount until the Participant's death.

Signed by the Company at XXXXXXX.

[ ]

[Secretary]

### Example C

There now follows an example of a so-called “guaranteed withdrawal benefit” rider for a variable annuity product which incorporates aspects of the invention.

XXXXX Insurance Company

Individual Variable Annuity Contract
2007

Section 15

Optional Guaranteed Minimum Withdrawal Benefit Rider (XXXX Plus)

The Guaranteed Minimum Withdrawal Benefit rider provides a guaranteed return of Deposits through periodic withdrawals regardless of the investment performance of the Units covered by the Guaranteed Minimum Withdrawal Benefit under the Contract, subject to the terms and conditions contained in this Section 15.

In general terms, this is achieved by tracking the GWB Base Amount for your GWB Units (based on either the Deposit or Aggregate Unit Value relating to those GWB Units when this rider is selected), which is adjusted upward or downward based on events such as additional Deposits, withdrawals, resets and 5% Bonuses. The GWB Adjusted Base Amount is then used to determine the Guaranteed Withdrawal Amount (generally 5% of the GWB Adjusted Base Amount) that can be withdrawn each year during the GWB Withdrawal Period (typically twenty years). The Remaining GWB is the aggregate amount of the remaining GWA payments that you are eligible to receive during the remainder of the GWB Withdrawal Period, which may be more or less than the Aggregate Unit Value of your GWB Units. This is a summary description only. Please refer to the Sections below which contain the full terms and conditions of the Guaranteed Minimum Withdrawal Benefit.

If you select the Guaranteed Minimum Withdrawal Benefit for some or all of the Units allocated to the Contract, various provisions in the Contract applicable to the Non-GWB Units allocated to the Contract also will change as described in Section 15.19 below.

All withdrawals under the Guaranteed Minimum Withdrawal Benefit constitute withdrawals under the Contract as described in Section 3 of the Contract.

15.1 Definitions

In this Section 15:

“GWA” or “Guaranteed Withdrawal Amount” means the maximum amount you are eligible to withdraw without penalty each calendar year during the GWB Withdrawal Period for a particular Class of GWB Units;

“GWA Deferral” means an election by you to not receive some or all of the GWA for a particular year, as described in Section 15.9;

“GWB Addition” means a subsequent Deposit in GWB Units or subsequent selection of the Guaranteed Minimum Withdrawal Benefit to Non-GWB Units already allocated to the Contract, as described in Section 15.7;

“GWB Adjusted Base Amount” means the amount calculated in the manner described in this Section 15 as the GWB Adjusted Base Amount for a particular Class of GWB Units;

“GWB Base Amount” means the amount calculated in the manner described in this Section 15 as the GWB Base Amount for a particular Class of GWB Units;

“GWB Class Value” means the Aggregate Unit Value of all the GWB Units of the same Class allocated to the Contract;

“GWB Election Deadline” means the date which is the earlier of: (a) the 80th birthday of the Annuitant, and (b) the date which is twenty years prior to the Contract Maturity Date;

“GWB Fee” means the fee charged for providing the Guaranteed Minimum Withdrawal Benefit, calculated in the manner described in Section 15.12;

“GWB Payment Commencement Date” means, for each Class of GWB Units allocated to the Contract, the earliest of: (a) the date you specify in your written notice to us as the date on which you wish the GWB Withdrawal Period to begin for that Class of GWB Units, (b) the date on which you make your first Redemption of GWB Units of that Class, and (c) the GWB Election Deadline;

“GWB Reference Date” means December 31 of the year immediately preceding the calendar year in which the Guaranteed Minimum Withdrawal Benefit is first selected for a particular Class of GWB Units;

“GWB Units” means Class A(GWB) Units, Class B(GWB) Units, Class C(GWB) Units, Class PMA(A)(GWB) Units, Class PMA(B)(GWB) Units or Class PMA(C)(GWB) Units for which you have selected the Guaranteed Minimum Withdrawal Benefit to apply;

“GWB Withdrawal Period” means, for each Class of GWB Units allocated to the Contract, the period commencing on the GWB Payment Commencement Date and ending on the earliest of: (a) the date of which the Remaining GWB is reduced to nil, (b) the Contract Maturity Date, (c) the date of which the Death Benefit becomes payable, and (d) the date on which the Contract is terminated;

“GWB Withdrawal Term” means, for each Class of GWB Units allocated to the Contract, our estimate of the number of years remaining until the Remaining GWB is reduced to nil. This estimate is based on the Remaining GWB and the GWA;

“Non-GWB Units” means Units of a Class other than GWB Units;

“Prorated” means an adjustment to an amount where, in respect of a calendar year, the amount is reduced to be a proportion equal to N/12 of the amount where “N”=the number of months remaining in such calendar year including the month in which the proration is calculated, unless expressly indicated otherwise;

“Remaining GWB” means the amount calculated in the manner described in this Section 15 as the Remaining GWB for a particular Class of GWB Units;

“5% Bonus” means a bonus amount as described in Section 15.8; and

“5% Bonus Year” means each of (a) the partial calendar year immediately following the GWB Reference Date, commencing with the date in which the Guaranteed Minimum Withdrawal Benefit is selected to apply to the GWB Units, and (b) the ten calendar years immediately following thereafter; provided, in each case, that no GWB Units have been Redeemed in such calendar year or partial calendar year (other than to pay fees and charges under the Contract).

15.2 Selecting the Guaranteed Minimum Withdrawal Benefit

You may, at any time and from time to time prior to the GWB Election Deadline, select the Guaranteed Minimum Withdrawal Benefit to apply to some or all of the Non-GWB Units allocated to the Contract.

15.3Guaranteed Benefits under the Guaranteed Minimum Withdrawal Benefit

As GWB Units are different Classes of Units from Non-GWB Units, the Guaranteed Benefits under the Contract will be calculated separately for each Class of GWB Units and Non-GWB Units. If you select the Guaranteed Minimum Withdrawal Benefit to apply to Non-GWB Units, those Non-GWB Units will be reclassified as GWB Units but the Guaranteed Benefits associated with those Units will remain unaffected for purposes of calculating the future Guaranteed Benefits associated with those Units.

You may change the Guarantee Option applicable to Non-GWB Units allocated to the Contract at the time that you select the Guaranteed Minimum Withdrawal Benefit to apply to those Non-GWB Units.

15.4 Holding more than one Class of GWB Units

The Guaranteed Minimum Withdrawal Benefit is calculated separately for each Class of GWB Units allocated to the Contract. Consequently, if more than one Class of GWB Units is allocated to the Contract, each Class of GWB Units will have its own Guaranteed Minimum Withdrawal Benefit and we will perform separate calculations of the amounts described in this Section 15 for each Class of GWB Units.

15.5 Tracking your Guaranteed Minimum Withdrawal Benefit

The first time that you select the Guaranteed Minimum Withdrawal Benefit, we will calculate a GWB Base Amount which will consist of: (a) if you purchase GWB Units with a Deposit, the amount of such Deposit, and (b) if you select the Guaranteed Minimum Withdrawal Benefit to apply to Non-GWB Units already allocated to the Contract, the Aggregate Unit Value of such Units. We also will calculate a GWB Adjusted Base Amount and Remaining GWB that initially will be the same as the GWB Base Amount, but will change as described in this Section 15.

15.6 Guaranteed Withdrawal Amount (GWA) and Withdrawals

Commencing in the calendar year in which the GWB Payment Commencement Date occurs and in each subsequent calendar year during the GWB Withdrawal Period, you may withdraw up to the GWA without penalty. The “GWA” is equal to 5% of the GWB Adjusted Base Amount, but may be increased in certain circumstances to include GWA Deferrals. Notwithstanding the foregoing, the GWA will be Prorated for any year in which the Guaranteed Minimum Withdrawal Benefit is selected to apply to a Deposit in GWB Units or to Non-GWB Units already allocated to the Contract.

Throughout the remainder of the GWB Withdrawal Period, you will have the right to continue withdrawing up to the GWA each year without penalty. If all of the GWB Units allocated to the Contract are Redeemed by GWA payments before the end of the GWB Withdrawal Period, we will fund the remaining GWA payments as a benefit under the Contract and such payments will not be considered withdrawals under the Contract. This benefit will be paid annually or in accordance with our administrative practices at the time.

Except as described immediately above, each payment will constitute a withdrawal and will result in a Redemption of that number of GWB Units having an Aggregate Unit Value equal to the amount that is withdrawn. We also will reduce the Remaining GWB by an amount equal to each withdrawal.

15.7 Increases for Subsequent Deposits and Selections

Each time that you make a subsequent Deposit in GWB Units or select the Guaranteed Minimum Withdrawal Benefit to apply to Non-GWB Units already allocated to the Contract, we will add the amount of the Deposit or the Aggregate Unit Value of such Non-GWB Units, as the case may be, (in either case called the “GWB Addition”) to the GWB Base Amount and the Remaining GWB. In the year of the GWB Addition, the effect of the GWB Addition on the GWA will be Prorated. Any Guaranteed Benefits paid under the Contract are not considered a GWB Addition.

(a) Before the GWB Withdrawal Period

If the GWB Addition occurs prior to the GWB Withdrawal Period, we also will add the GWB Addition to the GWB Adjusted Base Amount. We also will recalculate the GWA to an amount equal to 5% of the new GWB Adjusted Base Amount. The GWA will be further adjusted to Prorate this amount for the year the GWB Addition is made, as follows:
GWA for the year the GWB Addition is made=GWA prior to the GWB Addition+[(GWA immediately following the GWB Addition−GWA prior to the GWB Addition)×(N÷12)]

where N=the number of months from the date of the GWB Addition including the month of the GWB Addition to the end of the year.

(b) During the GWB Withdrawal Period

If the GWB Addition occurs during the GWB Withdrawal Period, we will recalculate the GWB Withdrawal Term as follows:

New GWB Withdrawal Term=[(Remaining GWB immediately prior to the GWB Addition×Number of remaining years in the GWB Withdrawal Term immediately prior to the GWB Addition)+(GWB Addition×20)]÷Remaining GWB

immediately following the GWB Addition

We will then recalculate the GWB Adjusted Base Amount to an amount equal to 20 multiplied by the new Remaining GWB, divided by the new GWB Withdrawal Term.

We also will recalculate the GWA to an amount equal to 5% of the new GWB Adjusted Base Amount. The GWA will be further adjusted to Prorate this amount for the year the GWB Addition is made, as follows:
GWA for the year the GWB Addition is made=GWA prior to the GWB Addition+[(GWA immediately following the GWB Addition−GWA prior to the GWB Addition)×(N÷12)]

where N=the number of months from the date of the GWB Addition including the month of the GWB Addition to the end of the year.

15.8 Increases for 5% Bonuses

On December 31 of each 5% Bonus Year, we will calculate an amount (a “5% Bonus”) equal to 5% of the GWB Base Amount. The 5% Bonus will be Prorated for any year in which the Guaranteed Minimum Withdrawal Benefit is selected to apply to a Deposit in GWB Units or to Non-GWB Units already allocated to the Contract.

(a) Before the GWB Withdrawal Period

On December 31 of each 5% Bonus Year before the GWB Withdrawal Period, we will add the 5% Bonus to the GWB Adjusted Base Amount and to the Remaining GWB. We also will recalculate the GWA to an amount equal to 5% of the new GWB Adjusted Base Amount.

(b) During the GWB Withdrawal Period

On December 31 of each 5% Bonus Year that occurs within the GWB Withdrawal Period, we will add the 5% Bonus to the Remaining GWB. We also will add to the GWB Adjusted Base Amount the amount determined using the following formula:
5% Bonus×20/N,

where N=the number of calendar years remaining in the GWB Withdrawal Term before the 5% Bonus is added.

We then will recalculate the GWA to an amount equal to 5% of the new GWB Adjusted Base Amount. 15.9 GWA Payment Options

You may instruct us to pay the GWA to you monthly, quarterly, semi-annually or annually. If you select a frequency greater than annually, we will divide the amount of each GWA payment by the number of payments to be made during the calendar year.

For any withdrawal, you must instruct us from which Funds and which Class of GWB Units you wish your GWA payments to be made and the dates on which the GWA payments are to be made. If the GWB Withdrawal Period commences without us having received these instructions from you, you will be deemed to have selected to defer receipt of all your GWA payments until we receive from you the instructions referred to above. If you have more than one Class of GWB Units allocated to the Contract, you may provide us with the same or different instructions for each Class of GWB Units.

If you do not withdraw all of your GWA in a particular year during the GWB Withdrawal Period, the amount that you do not withdraw (the “GWA Deferral”) will be added to the GWA for the next year. Notwithstanding the foregoing: (a) a GWA Deferral in a 5% Bonus Year will not be added to the GWA, but GWA Deferrals from prior years will not be affected by an intervening 5% Bonus Year; and (b) in no case can the GWA exceed 15% of the GWB Adjusted Base Amount.

For greater certainty, a GWA Deferral will be reset to zero each time the Remaining GWB is reset in accordance with Section 15.10 or Section 15.11, since the GWA Deferral amount is embedded in the reset calculation.

15.10 Automatic Resets

On every third anniversary of the GWB Reference Date, we will compare the Remaining GWB to the GWB Class Value.

(a) Before the GWB Withdrawal Period

If the GWB Withdrawal Period has not commenced and the GWB Class Value is greater than the Remaining GWB, we will increase the GWB Base Amount, GWB Adjusted Base Amount and Remaining GWB to the GWB Class Value. We also will recalculate the GWA to an amount equal to 5% of the new GWB Adjusted Base Amount.

(b) During the GWB Withdrawal Period

If the GWB Withdrawal Period has commenced and the GWB Class Value is greater than the Remaining GWB, we will (a) increase the GWB Base Amount and the Remaining GWB to the GWB Class Value, and (b) extend the GWB Withdrawal Term such that it will be equal to the new Remaining GWB divided by the GWA. If, however, such an adjustment would result in a GWB Withdrawal Term greater than twenty years, we will instead (a) increase the GWB Base Amount, GWB Adjusted Base Amount and Remaining GWB to the GWB Class Value, (b) change the GWB Withdrawal Term to twenty years, and (c) increase your GWA to an amount equal to 5% of the new GWB Adjusted Base Amount.

15.11 Withdrawals in Excess of the GWA

If in any calendar year you withdraw more than the GWA, we will (a) reset your GWB Base Amount, GWB Adjusted Base Amount and Remaining GWB to an amount equal to the GWB Class Value immediately following such withdrawal, and (b) recalculate the GWA to an amount equal to 5% of the GWB Adjusted Base Amount immediately following such reset. Notwithstanding the above, we reserve the right to allow you to make the excess withdrawal described above to a maximum of 10% of the GWA for that year (a “Permitted Excess Withdrawal”), in which event we instead will reduce the Remaining GWB by the amount of the Permitted Excess Withdrawal. This may shorten the GWB Withdrawal Period.

15.12 GWB Fees

Once you have selected the Guaranteed Minimum Withdrawal Benefit, we will charge you an annual fee (the “GWB Fee”) which is calculated as a percentage of the Remaining GWB on December 31 of the immediately preceding year and is paid on that same date. The annual percentage varies, based on the Class of GWB Units and how we categorize the Fund, as set out in the following table:

[omitted]

The GWB Fee will be deducted from your account by Redeeming a proportionate 30 number of GWB Units from all your Funds based on the Aggregate Unit Value of the GWB Units of each Fund allocated to the Contract. We may change the GWB Fee on 60 days notice to you.

The first time that you select the Guaranteed Minimum Withdrawal Benefit for a Class of GWB Units and each time that you make a GWB Addition, we will charge you a Prorated GWB Fee on the amount of such Deposit or Aggregate Unit Value of such Non-GWB Units, as applicable, which will be deducted from your account at the end of the calendar month by Redeeming a proportionate number of such Units based on the Aggregate Unit Value of such Units allocated to the Contract. In these circumstances, the calendar month in which the selection is made will not be included in “N” in the definition of Prorated.

GWB Units Redeemed in order to pay the GWB Fee will have no effect on the GWB Base Amount, GWB Adjusted Base Amount or Remaining GWB.

15.13 Minimum Purchase and Account Sizes

Under the Guaranteed Minimum Withdrawal Benefit, the GWB Class Value must be at least $25,000 at the time you select the Guaranteed Minimum Withdrawal Benefit. If you make a withdrawal in excess of the GWA and the GWB Class Value is less than $25,000 immediately following such withdrawal, we reserve the right to cancel the Guaranteed Minimum Withdrawal Benefit in respect of that Class of GWB Units and the Units will thereafter no longer constitute GWB Units.

15.14 Investment Options Under the Guaranteed Minimum Withdrawal Benefit

The Guaranteed Minimum Withdrawal Benefit may currently be selected for Units of all Funds, but there are limits on the proportions of Units of various Funds that may be included as GWB Units. We may change at any time in our discretion which Funds are available as GWB Units and in which proportions. We also may reallocate your GWB Units of one Fund to GWB Units of another Fund in order to comply with those restrictions. Currently, not less than 10% of the Aggregate Unit Value of your GWB Units must qualify for what we identify as “fixed income” in nature. Since the Funds invest their assets to varying degrees in securities which may be considered fixed income in nature, we will assign weightings from time to time to each Fund to identify the percentage of the Aggregate Unit Value of the GWB Units of that Fund allocated to the Contract that will qualify as fixed income in nature. This and other investment requirements may change from time to time in our discretion.

15.15 Rules for Registered Contracts

If the Contract is a RRIF, LIF, LRIF or PRIF and in any year during the GWB Withdrawal Period payment of the GWA would be less than the MAP for that year, we will increase the GWA for that year to the MAP. In such circumstances, the increase to the GWA will be treated as a Permitted Excess Withdrawal and the Remaining GWB will be reduced by the full amount of the increased payment, but the increase will not trigger a reset that otherwise applies to withdrawals in excess of the GWA. This treatment may affect the GWB Withdrawal Term.

If the Contract is a LIF or LRIF and in any year payment of the GWA would exceed the maximum payment amount permitted according to the formula specified by applicable legislation, the GWA for that year will be reduced to such maximum permitted payment amount and the reduction will be treated as a GWA Deferral. This treatment may affect the GWB Withdrawal Term.

Despite Section 15.15, in accordance with Section 12.7 for a Contract that is a RIF, LIF, LRIF or PRIF, should a spouse or common-law partner opt to continue to receive the periodic payments permitted under the Income Tax Act on the death of the Annuitant, the Guaranteed Minimum Withdrawal Benefit will continue to apply to those periodic payments.

15.16 Changes to Guarantee Options

When you select the Guaranteed Minimum Withdrawal Benefit to apply to Non-GWB Units, you also may change the Guarantee Option applicable to those Units. You also may change the Guarantee Option applicable to GWB Units. Changing to a lesser Guarantee Option (Class A to Class B or Class C; Class B to Class C) will result in a reduction in the Class Deposit Maturity Benefit and/or the Death Benefit associated with those Units.

(a) Non-GWB Units

If you change the Guarantee Option such that (a) the Class A Units or Class PMA(A) Units allocated to the Contract are reclassified as Class B(GWB) Units, Class PMA(B)(GWB) Units, Class C(GWB) Units or Class PMA(C)(GWB) Units, or (b) the Class B Units or Class PMA(B) Units allocated to the Contract are reclassified as Class C(GWB) Units or Class PMA(C)(GWB) Units, then the Benefit Determination Amount associated with those Non-GWB Units will become the Benefit Determination Amount of such GWB Units.

If you change the Guarantee Option such that (a) the Class B Units or Class PMA(B) Units allocated to the Contract are reclassified as Class A(GWB) Units or Class PMA(A)(GWB) Units, or (b) Class C Units or Class PMA(C) Units are reclassified as Class A(GWB) Units, Class PMA(A)(GWB) Units, Class B(GWB) Units or Class PMA(B)(GWB) Units, then the Benefit Determination Amount associated with those Units will be reset to the Aggregate Unit Value of such Units.

(b) GWB Units

If you change the Guarantee Option of GWB Units, the Benefit Determination Amount will be affected in the same manner as described above for changing the Guarantee Option of Non-GWB Units. However, the GWB Units that are reclassified will be treated as a withdrawal and the new GWB Units resulting from the reclassification will be treated as a GWB Addition. The GWB Fee charged at the time of such change to the Guarantee Option will be the amount (if any) by which (i) the GWB Fee calculated as a GWB Addition in respect of the GWB Units that are reclassified, exceeds (ii) the portion of the GWB Fee paid in respect of those reclassified GWB Units on December 31 of the immediately preceding year, Prorated using the same proportion used to Prorate the GWB Fee for such GWB Addition.

15.17 Conclusion of the GWB Withdrawal Period

At the end of the GWB Withdrawal Period, no further amounts will be payable under the Guaranteed Minimum Withdrawal Benefit and this rider will be cancelled.

15.18 Cancellation of the Guaranteed Minimum Withdrawal Benefit

You may notify us that you wish to cancel the Guaranteed Minimum Withdrawal Benefit. Any such cancellation will apply to all the GWB Units allocated to the Contract, which will be reclassified as Non-GWB Units. The Guaranteed Benefits associated with such Units will be unaffected for purposes of calculating the future Guaranteed Benefits associated with those Units.

15.19 Changes to the Contract

Once the Guaranteed Minimum Withdrawal Benefit is selected and for so long as it remains in effect, “Class” means a notional sub-account maintained for all the Units of all the Funds which carry the same Guarantee Option, except (i) for PMA Units which are divided into Classes based on whether they have a common PMA Guarantee Increase, and (ii) for GWB Units which are in different Classes than Non-GWB Units.

For greater certainty, the current Classes are Class A, Class A (GWB), Class B, Class B (GWB), Class C, Class C (GWB), Class PMA(A), Class PMA(A)(GWB), Class PMA(B), Class PMA(B)(GWB), Class PMA(C) and Class PMA(C)(GWB). All references throughout the Contract to (i) Class A shall be read to apply in the same manner to Class A, Class A(GWB), Class PMA(A) and Class PMA(A)(GWB), (ii) Class B shall be read to apply in the same manner to Class B, Class B(GWB), Class PMA(B) and Class PMA(B)(GWB), and (iii) Class C shall be read to apply in the same manner to Class C, Class C(GWB), Class PMA(C) and Class PMA(C)(GWB), except where indicated otherwise.

What is claimed is:

1. A method of providing to an entity an investment product of an annuity type, comprising:
a. arranging with the entity to provide, for at least a specified term, investment returns as a function of the performance of a predetermined index,
b. arranging to begin periodic payments on or after a predetermined date, at the election of the entity; and
c. in response to the entity deferring to receive one or more of said payments or portions thereof, allowing the entity to receive all or some portions of the deferred amounts at a later date of the entity's choosing.

2. The method of claim 1, further including:
d. in response to the entity electing to receive said deferred payments, making said one or more deferred payments or portions thereof to the entity.

3. The method of claim 1 wherein there is no payment by or diminution of investment return to the entity by virtue of having a right to make said election, until said election is made.

4. The method of claim 1 further including changing said function in response to said election, to change the investment returns as a function of the index.

5. The method of claim 2, wherein making said payments to the entity does not interfere with payment amounts of said periodic payments.

6. A method of providing by an issuer to an entity an investment product of an annuity type, comprising:
a. arranging with the entity to provide, for at least a specified term, investment returns substantially determined by the performance of one or more investment options selected in accordance with an acceptable risk profile,
b. arranging to begin periodic payments on or after a predetermined date, at the election of the entity;
c. in response to the entity deferring to receive one or more of said payments or portions thereof, allowing the entity to receive all or some portions of the deferred amounts at a later date of the entity's choosing.

7. The method of claim 6, further including:
d. in response to the entity electing to receive said deferred payments, making said one or more deferred payments or portions thereof to the entity.

8. The method of claim 7, wherein making said payments to the entity does not interfere with payment amounts of said periodic payments.

9. A method of providing to an entity an investment product of an annuity type, comprising:
a. arranging with the entity to provide, for at least a specified term, minimum fixed investment returns,
b. arranging to begin periodic payments on or after a predetermined date, at the election of the entity;
c. in in response to the entity deferring to receive one or more of said payments or portions thereof, allowing the entity to receive all or some portions of the deferred amounts at a later date of the entity's choosing.

10. The method of claim 9, further including:
d. in response to the entity electing to receive said deferred payments, making said one or more deferred payments or portions thereof to the entity.

11. The method of claim 10, wherein making said payments to the entity does not interfere with payment amounts of said periodic payments.

12. The method of any of claims 1-11, further including not charging said entity for a right to make said election until said election is made.

13. An annuity product comprising an agreement between an issuer and an entity, embodied in a tangible medium, and providing therein a right exercisable by the entity to begin receiving periodic payments on or after a predetermined date following payment of a premium, at the election of the entity; and further providing that if the entity elects not to receive one or more payments, the entity may elect to receive said one or more payments or portions thereof at a later date of the entity's choosing without interfering with receipt of subsequent payments or payment amounts.

14. The annuity product of claim 13 further providing that the investment return on the entity's premium is a function of the performance of a rate declared by the issuer.

15. The annuity product of claim 13 further providing that the investment return on the entity's premium is a function of the performance of one or more investment options selectable by the entity and acceptable to the issuer.

16. The annuity product of claim 13, further providing that the investment return on the entity's premium is a function of the performance of one or more indices.

17. A computer-implemented system for administering investment contracts with withdrawal benefits allowing each of a plurality of Certificate Owners to elect a date to begin receiving annual payments, defer payments when said date arrives, and obtain later payment of the deferred payments amounts of any part thereof, without impairing the right to future payments, comprising:
a. a data store;
b. a data structure in the data store, wherein there are maintained for each Certificate Owner at least one investment account and at least one interest account; and
c. one or more processing modules which operate to implement the method of at least one of claims 1-11.

18. The system of claim 17 further including:
d. a participation rate table constructed and arranged to receive and store a participation rate to be used if a certificate's lifetime benefit is inactive and a participation rate to be used if a certificate's lifetime benefit is active; and
e. a processing module to adjust a certificate owner's investment account value using an applicable one of said participation rates and an index value.

19. The system of claim 17 wherein said processing module makes no adjustment to said investment account if the index value is not positive.

20. A computer-implemented system for administering investment contracts with withdrawal benefits allowing each of a plurality of Certificate Owners to elect a date to begin receiving annual payments, defer payments when said date arrives, and obtain later payment of the deferred payments amounts of any part thereof, without impairing the right to future payments, comprising:
a. a data store;
b. a data structure in the data store, wherein there are maintained for each Certificate Owner at least one investment account and at least one interest account; and
c. one or more processing modules which operate to implement the product of at least one of claims 13-16.

21. The system of claim 20 further including:
d. a participation rate table constructed and arranged to receive and store a participation rate to be used if a certificate's lifetime benefit is inactive and a participation rate to be used if a certificate's lifetime benefit is active; and
e. a processing module to adjust a certificate owner's investment account value using an applicable one of said participation rates and an index value.

22. The system of claim 21 wherein said processing module makes no adjustment to said investment account if the index value is not positive.

23. A computer-implemented method of administering a plurality of investment accounts, comprising:
a. establishing in a data store a record of an index value for each of said annuity accounts;
b. establishing in a data store a record of at least one participation rate for each of said annuity accounts;
c. maintaining in a data structure for each of said annuity accounts a record of whether a lifetime benefit feature of the account has been activated;
d. maintaining in a data store an interest sub-account and an index sub-account for each of said accounts; and
computing for each said index sub-account an investment value change in response to a predetermined function using the record of whether a lifetime benefit feature has been activated for said account, a corresponding participation rate for the account and an index value for said account.
